(19) United States
(12) Patent Application Publication
(10) Pub. No.: US 2011/0025928 A1
(43) Pub. Date: Feb. 3, 2011

(54) ILLUMINATION DEVICE, DISPLAY DEVICE, AND TELEVISION RECEIVER APPARATUS

(75) Inventor: Masashi Yokota, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/867,775

(22) PCT Filed: Feb. 17, 2009
(86) PCT No.: PCT/JP2009/052663

§ 371 Date: Aug. 16, 2010

(30) Foreign Application Priority Data
Feb. 27, 2008 (JP) 2008-046784

(51) Int. Cl. H04N 5/66; F21V 21/00; F21S 4/00; F21V 7/00; F21V 5/00; G02F 1/13357; G02F 1/1335

(52) U.S. Cl. 348/739; 362/382; 362/249.01; 362/235; 362/311.01; 362/97.1; 349/61; 348/E05.133

(57) ABSTRACT

An illumination device includes a chassis 14, a cold cathode tube 17 housed in the chassis 14, a diffusing plate 15a arranged at a position on the other side of the cold cathode tube 17 on the chassis 14 and a lamp clip 18. The lamp clip 18 includes a main body 27 mounted to the chassis 14 and a lamp gripping portion 28 that is provided on the main body 27 so as to grip the cold cathode tube 17. The chassis 14 has a recess 46 in which the main body 27 is inserted.

### TECHNICAL FIELD

The present invention relates to an illumination device, a display device, and a television receiver apparatus.

### BACKGROUND ART

For example, since a liquid crystal panel used in a liquid crystal display device such as a liquid crystal television is not self-luminous, a backlight unit is separately required as an illumination device. Such a backlight unit is intended to be installed on a rear side (a side opposite to a display screen) of a liquid crystal panel, and includes: a metallic or resin chassis having a surface opened on the liquid crystal panel-side; a reflection sheet laid in the chassis; a large number of fluorescent tubes (for example, cold cathode tubes) housed as lamps in the chassis; a large number of optical members (for example, diffusion sheets) arranged at the opening of the chassis for efficiently emitting light generated by the cold cathode tubes to the liquid crystal panel-side; and a lamp clip for supporting center portions of the elongated and tubular cold cathode tubes.

A known example of a liquid crystal display device configured as described above is described in Patent Document 1 below. In this liquid crystal display device, holes are formed at bottom parts of a chassis and a reflection sheet and a mounting portion formed on a lamp clip is inserted in and locked by the holes in order to have the chassis hold the lamp clip and prevent a bottom part of the reflection sheet from moving in a planar direction.

Patent Document 1: Japanese Patent Laid-Open No. 2006-146126

### Problems to be Solved by the Invention

Thinning of a liquid crystal display device requires that components thereof be thinned and distances between the components be reduced. In doing so, shortening an interval between an optical member (opening) and a lamp may cause a so-called lamp image to become more visible and may create a risk of luminance unevenness. On the other hand, for example, while the thickness of a main body of the lamp clip can conceivably be reduced in order to maintain a predetermined interval between the optical member and the lamp, such reduction in thickness may result in undermining the strength of the main body.

### Disclosure of the Invention

The present invention has been made in consideration of circumstances as described above, and an object thereof is to prevent luminance unevenness and obtain sufficient strength of a main body.

### Means for Solving the Problems

An illumination device according to the present invention includes a lamp, a chassis and a lamp holder. The chassis houses the lamp and has an opening through which light is output. The lamp holder includes a main body mounted to the chassis and at least one lamp gripping portion provided on the main body and capable of gripping the lamp. The chassis has any one of a recess and a hole in which at least a part of the main body is inserted.

At least a part of the main body of the lamp holder is inserted in the recess or the hole of the chassis. Therefore, a sufficient gap can be achieved between the lamp held by the lamp gripping portion and the opening. Accordingly, luminance unevenness is less likely to occur. On the other hand, the part of the main body that is inserted in the recess or the hole has sufficient thickness and strength.

### BRIEF DESCRIPTION OF THE DRAWINGS

FIG. 1 is an exploded perspective view illustrating a schematic configuration of a television receiver apparatus according to a first embodiment of the present invention;

FIG. 2 is an exploded perspective view illustrating a schematic configuration of a liquid crystal display device;

FIG. 3 is a cross-sectional view illustrating a state where the liquid crystal display device is cut along a short side-direction thereof;

FIG. 4 is a cross-sectional view illustrating a state where the liquid crystal display device is cut along a long side-direction thereof;

FIG. 5 is a plan view illustrating lamp clips mounted on a chassis;

FIG. 6 is a cross-sectional view illustrating a mounted state of a lamp clip in the liquid crystal display device;

FIG. 7 is a plan view illustrating a state where a lamp clip is mounted on the chassis;

FIG. 8 is a cross-sectional view illustrating a mounted state of a lamp clip according to a second embodiment of the present invention;

FIG. 9 is a cross-sectional view illustrating a mounted state of a lamp clip according to a third embodiment of the present invention;

FIG. 10 is a cross-sectional view illustrating a mounted state of a lamp clip according to a fourth embodiment of the present invention;

FIG. 11 is a cross-sectional view illustrating a mounted state of a lamp clip according to a fifth embodiment of the present invention;

FIG. 12 is a cross-sectional view illustrating a mounted state of a lamp clip according to a sixth embodiment of the present invention;

FIG. 13 is a cross-sectional view illustrating a mounted state of a lamp clip according to a seventh embodiment of the present invention;

FIG. 14 is a cross-sectional view illustrating a mounted state of a lamp clip according to an eighth embodiment of the present invention;

FIG. 15 is a plan view illustrating a state where a lamp clip is mounted on a chassis;

FIG. 16 is a cross-sectional view illustrating a mounted state of a lamp clip according to a ninth embodiment of the present invention;

FIG. 17 is a cross-sectional view illustrating a mounted state of a lamp clip according to a tenth embodiment of the present invention;

FIG. 18 is a bottom view illustrating a state where a lamp clip is mounted on a chassis;

FIG. 19 is a cross-sectional view of a lamp clip according to other embodiment (2) of the present invention;

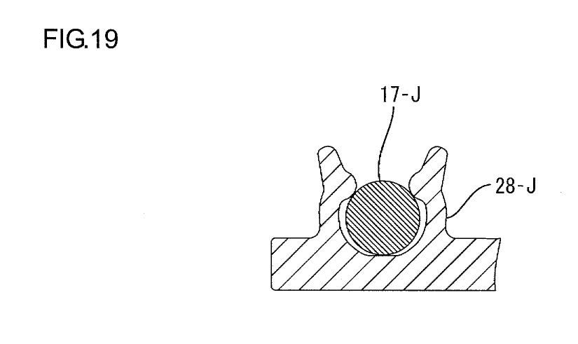

FIG. 20 is a cross-sectional view of a lamp clip according to other embodiment (3) of the present invention;

FIG. 21 is a cross-sectional view of a lamp clip according to other embodiment (4) of the present invention; and

FIG. 22 is a cross-sectional view of a lamp clip according to another embodiment (5) of the present invention.

### BEST MODE FOR CARRYING OUT THE INVENTION

### First Embodiment

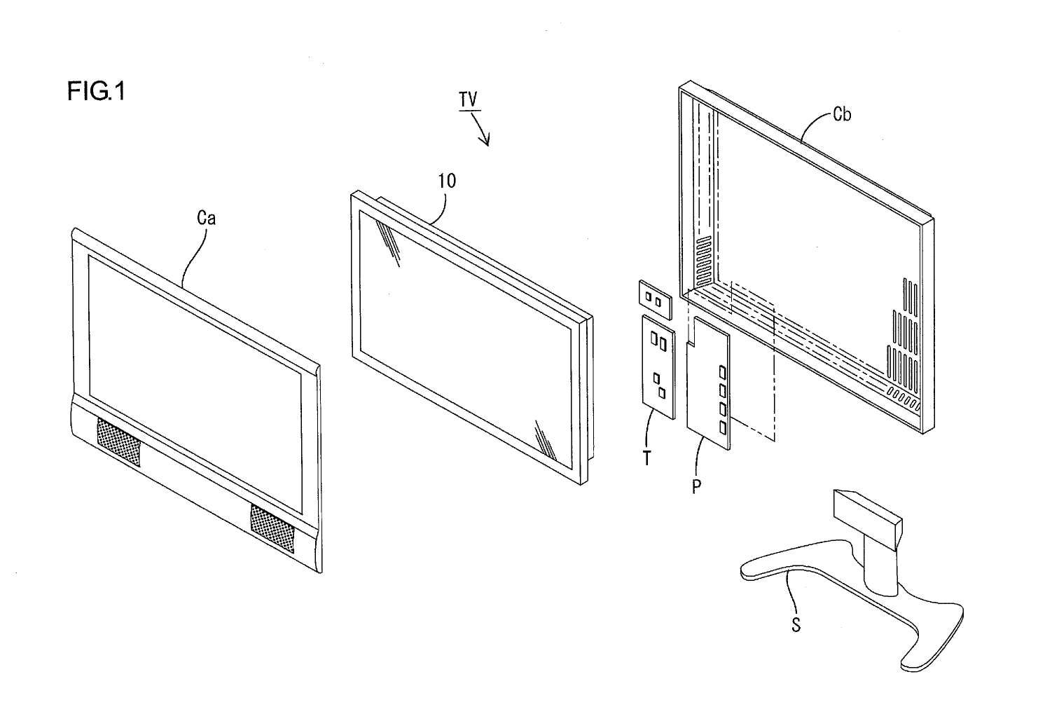

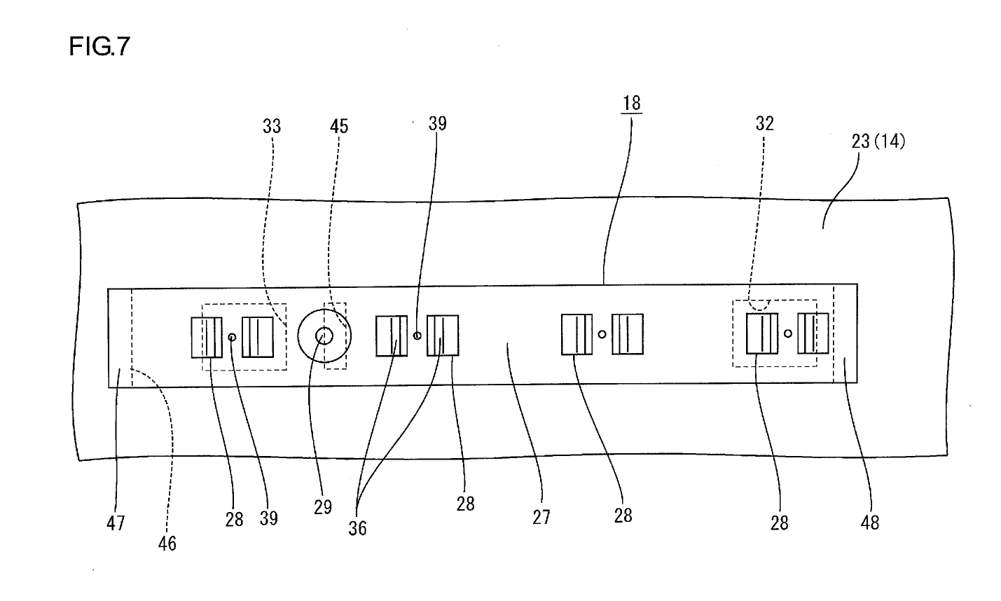

A first embodiment of the present invention will be described with reference to FIGS. 1 to 7.

As illustrated in FIG. 1, a television receiver apparatus TV according to the present embodiment includes: a liquid crystal display device 10; the front and rear cabinets

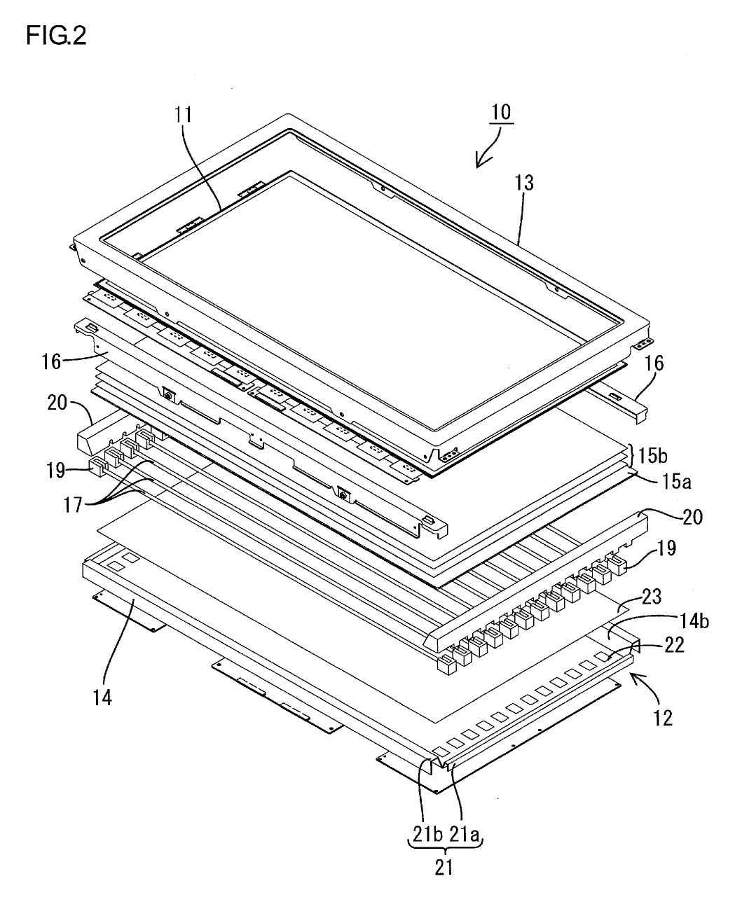

Ca and Cb that house the liquid crystal display device 10 so as to sandwich the same; a power source P; a tuner T; and a stand S. The liquid crystal display device (display device) 10 as a whole forms a horizontally long rectangle and is housed in an upright state. As illustrated in FIG. 2, the liquid crystal display device 10 includes a liquid crystal panel 11 that is a display panel and a backlight unit (illumination device) 12 that is an external light source. The liquid crystal panel 11 and the backlight unit 12 are integrally held by a frame-like bezel 13 and the like. Moreover, an X-axis, a Y-axis, and a Z-axis illustrated in parts of the respective drawings are depicted such that the direction of each axis is as illustrated in the drawings.

Next, the liquid crystal panel 11 and the backlight unit 12 constituting the liquid crystal display device 10 will be described (refer to FIGS. 2 to 4).

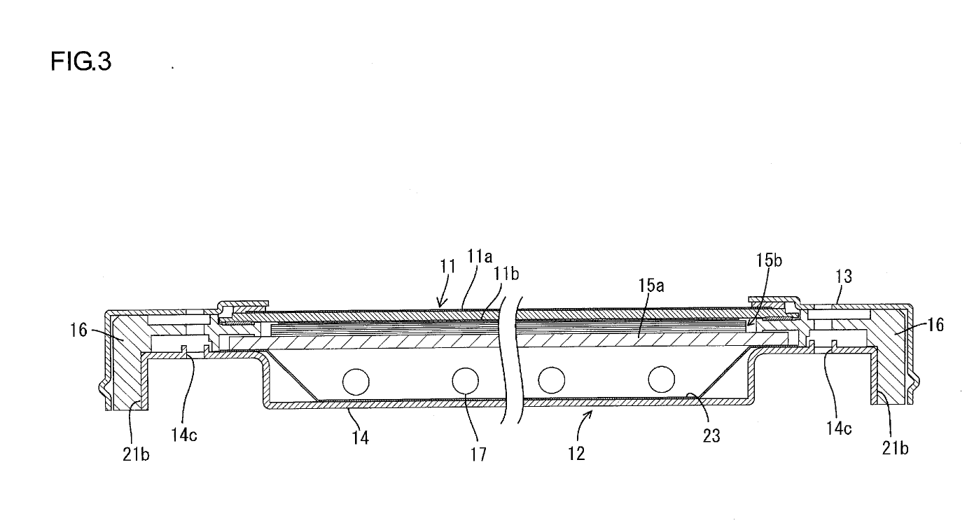

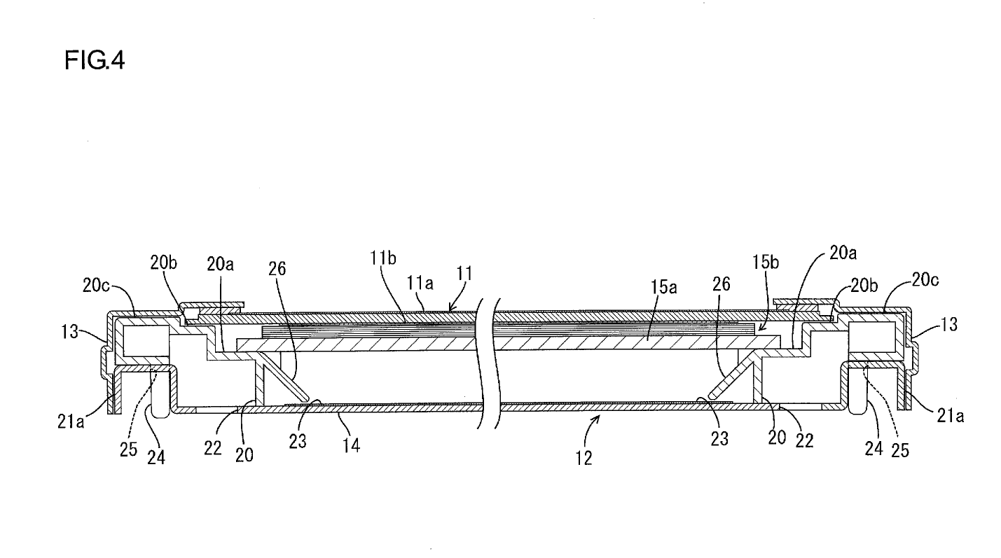

For the liquid crystal panel (display panel) 11, a pair of glass substrates is pasted together while being separated by a predetermined gap and liquid crystals are sealed between the two glass substrates. One of the glass substrates is provided with a switching element (for example, a TFT) connected to a source wiring and a gate wiring that intersect each other at right angles, a pixel electrode connected to the switching element, an alignment layer, and the like. The other glass substrate is provided with a color filter on which colored portions such as R (red), G (green) and B (blue) are arranged in a predetermined alignment, a counter electrode, an alignment layer, and the like. Moreover, polarizing plates 11a and 11b are arranged on the outsides of the substrates (refer to FIGS. 3 and 4).

As illustrated in FIG. 2, the backlight unit 12 includes: an approximately box-shaped chassis 14 opened to a side of a light outputting surface (a side of the liquid crystal panel 11); a diffusing plate 15a arranged so as to cover an opening 14b of the chassis 14; a plurality of optical sheets 15b arranged between the diffusing plate 15a and the liquid crystal panel 11; and a frame 16 that is arranged along a long side of the chassis 14 and that holds a long-side edge part of the diffusing plate 15a by sandwiching the same between the chassis 14. Furthermore, the chassis 14 is interiorly provided with: a cold cathode tube (light source) 17; a lamp clip 18 for mounting the cold cathode tube 17 to the chassis 14; relay connectors 19 responsible for relaying electrical connections at each end part of the cold cathode tube 17; and a holder 20 that covers all of the end parts of a group of cold cathode tubes 17 and a group of relay connectors 19. Moreover, at the backlight unit 12, the diffusing plate 15a is closer to the light-output side than the cold cathode tube 17. Note that the lamp clip 18 has been omitted in FIGS. 2 to 4.

The chassis 14 is metallic and is sheet-metal processed and molded in a shallow, approximately box shape made up of: a rectangular bottom plate; and a folded outer-edge part 21 rising from the respective sides of the bottom plate and folded in an approximate U-shape (a folded outer-edge part 21a in a short-side direction and a folded outer-edge part 21b in a long-side direction). A plurality of mounting holes 22 for mounting the relay connectors 19 is drilled on the long-side end parts of the bottom plate of the chassis 14. In addition, as illustrated in FIG. 3, a fixing hole 14c is drilled in an upper surface of the folded outer-edge part 21b of the chassis 14. For example, the fixing hole 14c enables the bezel 13, the frame 16, the chassis 14 and the like to be integrated by a screw or the like.

A reflection sheet 23 is arranged on an inner-surface side (a side of the surface opposing the cold cathode tube 17 and the diffusing plate 15a, a front-surface side) of the bottom plate of the chassis 14. The reflection sheet 23 is made of synthetic resin, has a surface colored white that is a color with superior reflectivity, and is laid along the inside of the bottom plate surface of the chassis 14 so as to approximately cover the entire area of the bottom plate surface of the chassis 14. The reflection sheet 23 constitutes a reflecting surface that reflects light emitted from the cold cathode tube 17 toward the diffusing plate 15a in the chassis 14. As illustrated in FIG. 3, a long-side edge part of the reflection sheet 23 rises so as to cover the folded outer-edge part 21b of the chassis 14 and is held between the chassis 14 and the diffusing plate 15a. The reflection sheet 23 reflects light emitted from the cold cathode tube 17 toward the diffusing plate 15a.

The cold cathode tube 17 has an elongated tubular shape. A large number of the cold cathode tubes 17 are housed in the chassis 14 aligned parallel to each other in a state where a longitudinal direction (axial direction) of the cold cathode tubes 17 is matched with the long-side direction of the chassis 14 (refer to FIG. 2). Moreover, the cold cathode tube 17 is arranged so as to be slightly elevated off of the bottom plate (reflection sheet 23) of the chassis 14. Each end part of the cold cathode tube 17 is fit in a relay connector 19, and the holder 20 is mounted so as to cover the relay connectors 19.

The holder 20 is made of white synthetic resin and covers the ends of the cold cathode tubes 17, and has an approximately elongated box shape extending along the short-side direction of the chassis 14. As illustrated in FIG. 4, the holder 20 has a stepped surface configured such that the diffusing plate 15a and the liquid crystal panel 11 can be mounted on different levels of a front-surface side of the stepped surface. The holder 20 is arranged so as to partially overlap with the folded outer-edge part 21a in the short-side direction of the chassis 14 and, together with the folded outer-edge part 21a, forms a side wall of the backlight unit 12. An insertion pin 24 protrudes from a surface opposing the folded outer-edge part 21a of the chassis 14 among the holder 20. The holder 20 is mounted to the chassis 14 by inserting the insertion pin 24 in an insertion hole 25 formed on an upper surface of the folded outer-edge part 21a of the chassis 14.

The stepped surface of the holder 20 is made up of three faces parallel to the bottom plate surface of the chassis 14. A short-side edge part of the diffusing plate 15a is mounted on a lowermost first surface 20a. In addition, an inclined cover 26 that inclines toward the bottom plate surface of the chassis 14 extends from the first surface 20a.

A short-side edge part of the liquid crystal panel 11 is mounted on a second surface 20b of the stepped surface of the holder 20. A topmost third surface 20c of the stepped surface of the holder 20 is arranged at a position overlapping the folded outer-edge part 21a of the chassis 14 and is in contact with the bezel 13.

The diffusing plate 15a is a synthetic resin plate-like member dispersedly mixed with light-scattering particles and functions to diffuse linear light radiated from the cold cathode tube 17 that is a tubular light source. As described above, the short-side edge part of the diffusing plate 15a is mounted on the first surface 20a of the holder 20 and is configured so as to be unaffected by vertical binding forces. On the other hand, as illustrated in FIG. 3, the long-side edge part of the diffusing plate 15a is held between and therefore fixed by the chassis 14 (reflection sheet 23) and the frame 16.

An optical sheet 15b arranged on the diffusing plate 15a is a laminated structure of a diffusing sheet, a lens sheet, and a reflective polarizing plate, in this order, from the side of the diffusing plate 15a, and functions to convert light radiated from the cold cathode tube 17 and passed through the diffusing plate 15a in planar light. The liquid crystal panel 11 is placed on an upper surface-side of the optical sheet 15b. The optical sheet 15b is held between the diffusing plate 15a and the liquid crystal panel 11.

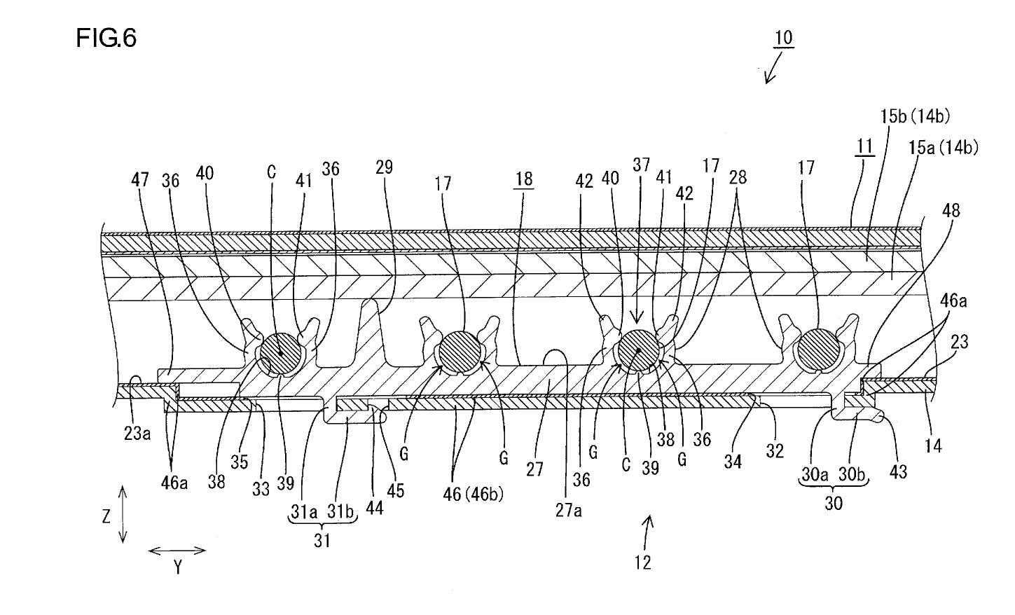

The lamp clip 18 will now be described in detail. The lamp clip 18 is made of synthetic resin (for example, polycarbonate) and has a surface colored white that is a color with superior reflectivity. As illustrated in FIG. 6, the lamp clip 18 has an approximately plate-like shape along the bottom plates of the chassis 14 and the reflection sheet 23, and includes a main body 27 (mounting plate, base portion) that is approximately rectangular as seen in plan view. The lamp clip 18 is mounted to the chassis 14 such that a longitudinal direction (long-side direction) of the main body 27 follows the Y-axis direction and the posture (orientation, state) of the lamp clip 18 is approximately parallel to the short-side direction of the chassis 14 or, in other words, approximately parallel to a direction perpendicular to an axial direction (longitudinal direction, X-axis direction) of the cold cathode tube 17. Hereinafter, the upper side with respect to the Z-axis direction as depicted in FIG. 6 will be referred to as a front side and the opposite lower side will be referred to as a rear side.

A front-side surface (a surface opposing the diffusing plate 15a and the cold cathode tube 17, a surface opposite to the side of the chassis 14) of the main body 27 is provided with a lamp gripping portion 28 for supporting the cold cathode tube 17 at a predetermined height position and a supporting pin 29 for supporting the diffusing plate 15a at a position higher than the cold cathode tube 17. A plurality (four in the present embodiment) of the lamp gripping portions 28 is installed aligned at positions separated from each other in the longitudinal direction of the main body 27 and respectively grips a different cold cathode tube 17. Spacing between the lamp gripping portions 28 is set approximately equal and is consistent with the spacing between the cold cathode tubes 17 aligned in the chassis 14. Each lamp gripping portion 28 is arranged at a position point-symmetrical with respect to a center of the main body 27 or, more specifically, a central position in the long-side direction (longitudinal direction, Y-axis direction) of the main body 27 that is also a central position in the short-side direction (width direction, X-axis direction) of the main body 27. Each lamp gripping portion 28 is arranged at a position displaced by a predetermined distance from the center of the main body 27. The supporting pin 29 is arranged on the main body 27 at a position deviated (displaced) from the center described above or, in other words, an eccentric position on the main body 27. The supporting pin 29 is arranged approximately at a central position between a lamp gripping portion 28 closest to the end and an adjacent lamp gripping portion 28 thereof on the main body 27. On the other hand, a rear-side surface (a surface opposing the chassis 14 and the reflection sheet 23, a surface opposite to the side of the diffusing plate 15a and the cold cathode tube 17) of the main body 27 is provided with two mounting portions 30, 31 for holding the lamp clip 18 in a mounted state with respect to the chassis 14. The mounting portions 30, 31 are arranged at positions separated from each other in the long-side direction of the main body 27. To distinguish the mounting portions 30, 31 from each other, in order from the left side of FIG. 6, the mounting portions are referred to as a first mounting portion 30 and a second mounting portion 31.

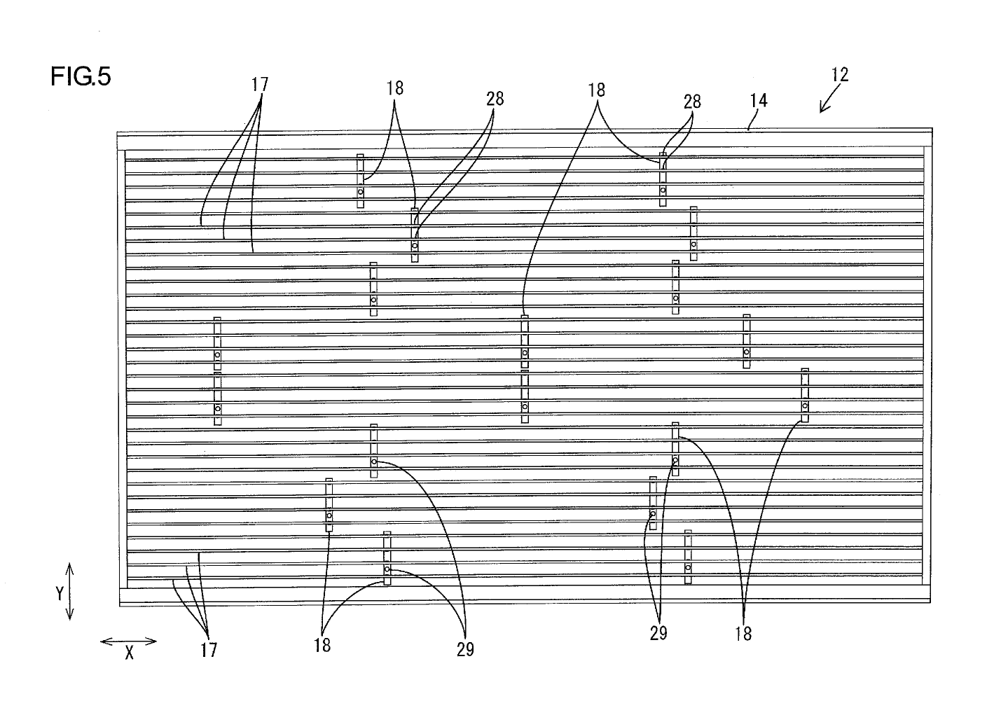

As illustrated in FIG. 5, the lamp clips 18 are arranged at a plurality of positions dispersed on inner faces of the bottom plates of the chassis 14 and the reflection sheet 23. The arrangement of the lamp clips 18 will be described below. The lamp clips 18 are placed at a plurality of positions separated from each other in the long-side direction (X-axis direction) of the chassis 14 and the reflection sheet 23 and, as a result, are capable of gripping the cold cathode tubes 17 at a plurality of positions separated from each other in the axial direction. Furthermore, the number of lamp clips 18 placed on the bottom plates of the chassis 14 and the reflection sheet 23 is greater towards the center than towards the ends in the short-side direction (Y-axis direction). Specifically, compared to two groups of three lamp clips 18 placed separated from each other in the long-side direction near the center in the short-side direction of the chassis 14 and the reflection sheet 23, pairs of lamp clips 18 are placed separated in the long-side direction of the chassis 14 and the reflection sheet 23 near the ends in the short-side direction as seen from the six lamp clips 18 near the center. Accordingly, the number of lamp gripping portions 28 or, in other words, support locations with respect to the cold cathode tubes 17, as well as the number of supporting pins 29 or, in other words, support locations with respect to the diffusing plate 15a, are greater near the center in the short-side direction of the chassis 14 and the reflection sheet 23 than near the ends.

Each lamp clip 18 (each of the lamp clips 18 arranged near the ends in the short-side direction as compared to near the center thereof) aligned in pairs in the long-side direction of the chassis 14 and the reflection sheet 23 is arranged at a position displaced in the long-side direction from a lamp clip 18 adjacent in the short-side direction. Therefore, compared to a hypothetical case where the lamp clips 18 are arranged in a single row along the short-side direction, the dispersed arrangement of the lamp clips 18 in the bottom plate surface of the reflection sheet 23 makes shadows of the lamp clips 18 less visible due to characteristics of the human eye. In other words, even if the number of the lamp clips 18 is the same, a linear or concentrated arrangement makes the lamp clips 18 more visible due to characteristics of the human eye. On the other hand, by arranging the lamp clips 18 so as to be dispersed as in the present embodiment, luminance unevenness is less likely to occur at the backlight unit 12 even if light reflectance differs between the reflection sheet 23 and the lamp clips 18.

The bottom plate of the chassis 14 and that of the reflection sheet 23 have mounting holes 32, 33 and insertion holes 34, 35, respectively, in which the mounting portions 30, 31 are inserted, respectively, to mount the lamp clip 18 at a predetermined position. The mounting holes 32, 33 and the insertion holes 34, 35 run through the bottom plate and the reflection sheet 23 in the thickness direction thereof, respectively. To distinguish the mounting holes 32, 23 from each other and the insertion holes 34, 35 from each other, they are referred to as a first mounting hole 32, a first insertion hole 34, a second mounting hole 33 and a second insertion hole 35, which are located in this order from the left side of FIG. 6. The mounting portions 30, 31, the mounting holes 32, 33, and the insertion holes 34, 35 will be described later in detail.

The lamp gripping portion 28 that constitutes a supporting structure of the cold cathode tube 17 will be described in detail. As illustrated in FIG. 6, the lamp gripping portion 28 supports a middle part of the cold cathode tube 17, that is, a light emitting part, between ends at which electrodes are provided. The lamp gripping portion 28 supports the cold cathode tube 17 from a rear side and at a height slightly above the reflection sheet 23. The lamp gripping portion 28 has an overall shape of an open-ended ring having an opening on the front side and includes a pair of arm portions 36 that oppose each other. An opening 37 that permits insertion of the cold cathode tube 17 that is attachable and detachable in the Z-axis direction (a thickness direction of the bottom plates of the chassis 14 and the reflection sheet 23) is provided between the ends of the arm portions 36. The arm portions 36 have cantilever shapes, each of which continues from the front surface of the main body 27 at positions separated from each other in a longitudinal direction (Y-axis direction). Each arm portion 36 has an arc shape that curves along the periphery of the cold cathode tube 17 that is attached thereto. The arm portions 36 are symmetrical about a symmetrical axis that passes the center of the Y-axis of the lamp gripping portion 28 and extends in the Z-axis direction. Each arm portion 36 is elastically deformable in the width direction with a rising base-end, at which the arm portion 36 rises from the main body 27, as a pivot point. The widths of the arm portions 36 are smaller than the width of the main body 27.

As described above, the pair of arm portions 36 that constitute the lamp gripping portion 28 is arranged at positions separated from each other in the longitudinal direction on the front surface of the main body 27. Namely, a bottom surface of the inner surface (the surface opposing the cold cathode tube 17) of the lamp gripping portion 28 is also a part of the front surface of the main body 27. The main body 27 has a recessed portion 38 in the bottom surface. The recessed portion 38 is formed such that the front surface thereof is located lower than an outside portion 27a of the lamp gripping portion 28, that is, a distance from a recessed portion 38 to the diffusing plate 15 is larger. Namely, the main body 27 has a partially thin portion corresponding to the lamp gripping portion 28 (a portion where the recessed portion 38 is formed). The recessed portion 38 (bottom surface) is formed in an arc-shape that curves along the periphery of the cold cathode tube 17 mounted thereto and continues to inner surfaces of the respective arm portions 36 having similar arc-shapes. Furthermore, the recessed portion 38 is formed across the entire width of the main body 27.

Furthermore, a first supporting protrusion 39 that supports the cold cathode tube 17 gripped by the lamp gripping portion 28 from the rear side is provided in the recessed portion 38. The first supporting protrusion 39 is arranged at a central position of the recessed portion 38, that is, at a position the farthest away from the diffusing plate 15a (or the closest from the chassis 14). The arrangement position of the first supporting protrusion 39 is located at the midpoint between the arm portions 36 and directly below the center C of the cold cathode tube 17. The first supporting protrusion 39 has a substantially semi-annular cross-section and distal end portions that have point-contact with the periphery of the cold cathode tube 17. Since the cold cathode tube 17 is supported at a position the height of the first supporting protrusion 39 above (or away from) the bottom surface of the lamp gripping portion 28, a gap G is present between the periphery of the cold cathode tube 17 and the bottom surface of the lamp gripping portion 28. The height of the first supporting protrusion 39 from the recessed portion 38 is smaller than the depth of the recessed portion 38. Therefore, a lowermost point (a point at which the distance from the diffusing plate 15a is the largest) of the periphery of the cold cathode tube 17 is located lower (further away from the diffusing plate 15a) than the outside portion 27a of the front surface of the main body 27 outside the lamp gripping portion 28.

Moreover, a second supporting protrusion 40 and a third supporting protrusion 41 that support the cold cathode tube 17 are provided on the inner surface of the end portions of the arm portions 36, respectively. The opening 37 described earlier is present between the supporting protrusions 40, 41. The clearance of the opening 37 is slightly narrower than an outside diameter of the cold cathode tube 17. Therefore, the arm portions 36 elastically deform and expand when pushed by the cold cathode tube 17 during attachment or detachment of the cold cathode tube 17 through the opening 37. The supporting protrusions 40, 41 are formed so as to jut inwards (towards the central axis of the cold cathode tube 17) from an inner surface of the respective end portion of the arm portions 36. They are formed so as to cover the cold cathode tube 17 from the front side (light-output side), that is, on a side from which the cold cathode tube 17 is removed. Inner surfaces of the second supporting protrusion 40 and the third supporting protrusion 41 are curved surfaces formed in substantially arc-shapes. The innermost part of the inner surface of each supporting protrusion 40, 41 (a part that projects closest to the cold cathode tube 17) has point contact with the periphery of the cold cathode tube 17. Accordingly, the cold cathode tube 17 can be supported at a position the height of the second supporting protrusion 40 and the third supporting protrusion 41 away from the inner surfaces of the arm portions 36. Therefore, a gap G is present between the periphery of the cold cathode tube 17 and the inner surfaces of the arm portions 36.

When mounted, the cold cathode tube 17 is supported with a three-point support by the supporting protrusions 39 to 41. The gaps G are present between the supporting protrusions 39 to 41 so as to extend in a peripheral direction between the periphery of the cold cathode tube 17 and the inner surface of the lamp gripping portion 28. The size of the gaps G is approximately constant across all areas. When the cold cathode tube 17 is lit, light can be efficiently extracted to the outside of the lamp gripping portion 28 through the gaps G. Therefore, compared to a hypothetical case where the inner surface of the lamp gripping portion is brought in plane-contact with the outer surface of the cold cathode tube 17, light extraction efficiency can be improved. An isosceles triangle is drawn by connecting supporting points of the respective supporting protrusions 39 to 41 of the cold cathode tube 17. In addition, angles formed by a line connecting the supporting point of the first supporting protrusion 39 and the center C of the cold cathode tube 17, a line connecting the supporting point of the second supporting protrusion 40 and the center C, and a line connecting the supporting point of the third supporting protrusion 41 and the center C are obtuse angles.

Guide portions 42 for guiding a mounting operation of the cold cathode tube 17 are respectively provided on outer faces of the tip parts of the arm portions 36. The guide portions 42 are formed so as to have a tapered shape rising obliquely outward from the arm portions 36. The guide portions 42 have gradients that separate from each other from a protruding base end to a protruding tip. Inner faces opposing the cold cathode tube 17 are also arranged as sloped faces with similar gradients. Therefore, an interval of inner faces of the guide portions 42 that oppose each other gradually becomes narrower towards the bottom of FIG. 6 or, in other words, towards the side of a mounting direction of the cold cathode tube 17, and conversely gradually becomes wider towards the side of a removing direction of the cold cathode tube 17. Accordingly, the mounting operation of the cold cathode tube 17 can be smoothly guided by the inner faces of the guide portions 42. In addition, the inner faces of the guide portions 42 are smoothly connected as-is to the inner faces of the second supporting protrusion 40 and the third supporting protrusion 41.

Next, the supporting pin 29 constituting a support structure of the diffusing plate 15a will be described in detail. As illustrated in FIG. 6, the supporting pin 29 is capable of restricting bowing and warping of the diffusing plate 15a to the side of the cold cathode tube 17 by supporting the diffusing plate 15a from the rear at a position closer to the center of the screen than an outer edge part supported by the holder 20 and the like. The supporting pin 29 is arranged such that the shape of a cross section thereof cut along a horizontal direction is circular (FIG. 5) and is formed so as to have a tapered shape whose diameter gradually decreases from a root side to a tip side. In other words, the supporting pin 29 is formed so as to have an approximately conical shape. Among the supporting pin 29, a tip capable of coming in contact with the diffusing plate 15a is formed with an R surface and is rounded. The protruding height of the supporting pin 29 from the main body 27 is set higher than the lamp gripping portion 28. Accordingly, the supporting pin 29 is a site that protrudes to a highest position among the lamp clip 18. Therefore, when performing an attaching/detaching operation of the lamp clip 18 to/from the chassis 14, a worker can perform the operation by grasping the supporting pin 29, thereby enabling the supporting pin 29 to also function as an operating unit during attachment/detachment.

Next, the mounting portions 30, 31 of the lamp clip 18 constituting a holding structure for the chassis 14 will be described in detail together with the mounting holes 32, 33 and the insertion holes 34, 35 of the chassis 14 and the reflection sheet 23. The holding structure will be concisely described first. As illustrated in FIG. 6, the mounting portions 30, 31 have a hook shape that conforms to the rear surface (plate surface) of the main body 27. By inserting the mounting portions 30, 31 in the mounting holes 32, 33 and the insertion holes 34, 35 of the chassis 14 and the reflection sheet 23 so as to protrude to the rear side of the chassis 14 and sliding the lamp clip 18 along the longitudinal direction of the main body 27 (the Y-axis direction, the plate-surface direction of the bottom plates of the chassis 14 and the reflection sheet 23) in this state, the chassis 14 and the reflection sheet 23 can be held between the mounting portions 30, 31 and the main body 27.

The first mounting portion 30 and the second mounting portion 31 have a common structure that will now be described. The first mounting portion 30 and the second mounting portion 31 respectively include base portions 30a, 31a that protrude from the rear surface of the main body 27 and cantilevered protrusions 30b, 31b that protrude (extend) from tips of the base portions 30a, 31a, bend approximately in right angles, and then follow the long-side direction of the main body 27 so as to form an approximate L-shape as seen in plan view. The width and length dimensions of the first mounting portion 30 and the second mounting portion 31 are respectively set so as to be smaller than the short-side and the long-side dimensions of the main body 27.

Next, structures that differ between the first mounting portion 30 and the second mounting portion 31 will be described. At the first mounting portion 30, a guide portion 43 capable of guiding a mounting operation to the chassis 14 is provided on a tip of the protrusion 30b. The guide portion 43 is formed so as to have an incline such that the further towards the tip, the more separated the guide portion 43 becomes from the main body 27. Meanwhile, at the second mounting portion 31, a locking protrusion 44 is provided at the tip of the protrusion 31b so as to protrude to the side of the main body 27. Among the locking protrusion 44, a tapered surface is formed on a surface opposing the main body 27. A surface of the locking protrusion 44 opposing the base portion 31a is configured so as to be approximately parallel to an outer surface of the base portion 31a and upright, and approximately straight along a direction (Z-axis direction) perpendicular to a slide direction (Y-axis direction) of the lamp clip 18 with respect to the chassis 14. The surface functions as a locking surface for the chassis 14.

Next, the first mounting hole 32 and the second mounting hole 33 formed on the chassis 14 will be described. The first mounting hole 32 and the second mounting hole 33 are formed with sizes that allow insertion of the corresponding first mounting portion 30 and second mounting portion 31. Specifically, the first mounting hole 32 and the second mounting hole 33 are formed rectangular as seen in plan view so as to conform to the first mounting portion 30 and second mounting portion 31, and the length and width dimensions thereof are set smaller than the main body 27. When the lamp clip 18 is mounted, the first mounting hole 32 and the second mounting hole 33 are covered by the main body 27. In addition, a locking hole 45 capable of locking the locking protrusion 44 is formed at a position adjacent to the second mounting hole 33 on the chassis 14. The locking hole 45 is arranged at a position displaced from the second mounting hole 33 to the right as viewed in FIG. 6 or, in other words, in a protruding direction of the protrusion 31b (a sliding direction during mounting). In the same manner as the first mounting hole 32 and the second mounting hole 33, the size of the locking hole 45 as seen in plan view is set smaller than the main body 27. In a mounted state, the locking hole 45 is to be covered by the main body 27.

Next, the first insertion hole 34 and the second insertion hole formed on the reflection sheet 23 will be described. The first insertion hole 34 is set even larger than the first mounting hole 32. Meanwhile, the second insertion hole 35 is formed with a size capable of collectively surrounding the second mounting hole 33 and the locking hole 45. The differences in sizes between the first mounting hole 32 and the first insertion hole 34 and between the second mounting hole 33, the locking hole 52 and the second insertion hole 35 is set the same as or greater than an assumed maximum value of a positional displacement that may occur between the reflection sheet 23 and the chassis 14 when assembling the reflection sheet 23 to the chassis 14. Accordingly, the mounting holes 32, 33 and the locking hole 45 are reliably arranged on the insides of the respective insertion holes 34, 35 so as to avoid situations where the mounting holes 32, 33 or the locking hole 45 are covered by the reflection sheet 23. Moreover, the insertion holes 34, 35 are formed smaller as seen in plan view than the main body 27, and are covered by the main body 27 in a mounted state.

A recess 46 that allows penetration of the main body 27 of each lamp clip 18 is formed on a scheduled mounting position of each lamp clip 18 on the chassis 14 and the reflection sheet 23. The recess 46 is formed by having the bottom plates of the chassis 14 and the reflection sheet 23 partially protrude (depress) to the rear side or, in other words, in a direction receding from the diffusing plate 15a (to a side opposite to the diffusing plate 15a). The recess 46 is formed by subjecting the chassis 14 to a drawing process. The recess 46 is made up of a protruding peripheral wall part 46a that protrudes at an approximate right angle with respect to the bottom plates of the chassis 14 and the reflection sheet 23, and a bottom portion 46b approximately parallel to the bottom plates of the chassis 14 and the reflection sheet 23. A housing space for the main body 27 of the lamp clip 18 is retained in the recess 46. The mounting holes 32, 33 and the locking hole 45 of the chassis 14 and the respective insertion holes 34, 35 of the reflection sheet 23 are all formed on the bottom portion 46b that constitutes the recess 46 and therefore are to be reliably covered by the main body 27 that penetrates in the recess 46.

The recess 46 is formed rectangular as seen in plan view so as to conform to the main body 27. The size as seen in plan view of the recess 46 is larger than the main body 27. Therefore, the entire main body 27 is inserted in the recess 46. Specifically, the short-side dimension of the recess 46 is approximately the same as the short-side dimension of the main body 27 and the long-side dimension of the recess 46 is larger than the long-side dimension of the main body 27. The difference between the long-side dimensions is approximately equal to a sliding amount (a travel distance in the Y -axis direction) when attaching/detaching the lamp clip 18 to/from the chassis 14. When the lamp clip 18 is mounted, a front end of the main body 27 in the sliding direction (the right-side end in FIG. 6) abuts or sits adjacent to a front-side wall 46a of the recess 46. A rear end of the main body 27 in the sliding direction (the left-side end in FIG. 6) sits a distance corresponding to the sliding amount away from a rear-side wall 46 of the recess 46.

As described above, since a gap corresponding to the slide amount is present between the rear end of the main body 27 in the sliding direction. If the recess 46 is left as it is, the recess 46 is opened (or exposed) to the diffusing plate 15a side. Assuming that the recess 46 is opened to the side of the diffusing plate 15a, an edge portion 23a of the front surface of the reflection sheet 23 near the recess 46 (the reflecting surface of the chassis 14) is not on the same plane as the surface of the reflecting sheet 23 in the recess 46. Therefore, the opening of the recess 46 may be recognized as a dark area. In order to deal with such a problem, in the present embodiment, the main body 27 includes a recess covering portion 47 that covers the recess 46. The recess covering portion 47 is provided so as to protrude rearward in the sliding direction during mounting from the rear end part of the main body 27 in the sliding direction, and the protruding dimension thereof is larger than the sliding amount. When the lamp clip 18 is mounted, the recess covering portion 47 projects farther out than the inner wall 46a of the recess 46 and covers a part of the recess 46 at which the gap corresponding to the slide amount is present.

In addition, an auxiliary recess covering portion 48 is provided so as to protrude forward in the sliding direction during mounting from the front end part of the main body 27 in the sliding direction. Even when a gap is created during a mounted state between the aforementioned front end part of the main body 27 and the inner surface of the protruding peripheral wall part 46a of the recess 46 due to the influence of dimensional tolerance of the lamp clip 18 or the like, the auxiliary recess covering portion 48 is capable of covering such a gap. Accordingly, the recess 46 can be reliably prevented from being visually recognized as a dark area. Moreover, front-side surfaces of the recess covering portion 47 and the auxiliary recess covering portion 48 are approximately flush with the outside portion 27a of each lamp gripping portion 28 among the front-side surface of the main body 27 and protrude more towards the side of the diffusing plate 15a than the outside portion 23a of the recess 46 among the front surface of the reflection sheet 23. Furthermore, rear-side surfaces of the recess covering portion 47 and the auxiliary recess covering portion 48 abut the outside portion 23a of the recess 46 among the front surface of the reflection sheet 23.

A depth dimension (recess dimension) of the dimension 46 is set smaller than the thickness dimension (height dimension) of the main body 27. Therefore, among the entire thickness region of the main body 27, only a rear-side portion penetrates in the recess 46 and a front-side portion protrudes to the front side from the recess 46. The outside portion 27a of each lamp gripping portion 28 among the front-side surface of the main body 27 is arranged at a position higher than the outside portion 23a of the recess 46 among the front surface of the reflection sheet 23 or, in other words, at a position protruding to the side of the diffusing plate 15a (a position whose distance to the diffusing plate 15a is short). Meanwhile, a difference between the depth dimension of the recess 46 and the thickness dimension of the main body 27 is set approximately the same as or slightly greater than the depth dimension of the recessed portion 38 formed so as to correspond to each lamp gripping portion 28 among the main body 27. Therefore, the first supporting protrusion 39 installed at the recessed portion 38 is arranged at a position having approximately the same height as the outside portion 23a of the recess 46 among the front surface of the reflection sheet 23 (a position whose distance to the diffusing plate 15a is approximately the same) or at a position higher than the outside portion 23a. More specifically, the cold cathode tube 17 to be supported by the first supporting protrusion 39 is to be arranged at a slightly higher position than the outside portion 23a of the recess 46 among the front surface of the reflection sheet 23.

As described above, since the recess 46 in which the main body 27 of the lamp clip 18 penetrates is formed on the chassis 14, the interior space of the chassis 14 is to expand by just the depth dimension of the recess 46. Accordingly, using the expanded space, the distance between the cold cathode tube 17 and the diffusing plate 15a and the thickness dimension (thickness) of the main body 27 can be relatively increased as compared to a case where the expanded space is not provided. Increasing the distance between the cold cathode tube 17 and the diffusing plate 15a reduces the likelihood of visual recognition of a lamp image during lighting of the cold cathode tube 17 that is a linear light source and is effective in resolving luminance unevenness of the backlight unit 12. On the other hand, increasing the thickness of the main body 27 is effective in maintaining the strength of the main body 27, and enables the recessed portion 38 to be provided at a portion corresponding to the lamp gripping portion 28 on the main body 27 for the purpose of increasing the distance between the cold cathode tube 17 and the diffusing plate 15a, or the first supporting protrusion 39 to be provided between the cold cathode tube 17 and the lamp gripping portion 28 for the purpose of securing a gap G for improving light extraction efficiency. According to the above, thinning of the backlight unit 12 and the liquid crystal display device 10 can be favorably achieved.

The present embodiment is configured as described above. Next, operations of the present embodiment will be described. The liquid crystal panel 11 and the backlight unit 12 are separately manufactured and then assembled using the bezel 13 and the like to produce the liquid crystal display device 10 illustrated in FIGS. 3 and 4. Next, an assembly operation of the backlight unit 12 and, more particularly, an operation for mounting the lamp clip 18 to the chassis 14 will be described in detail.

When the reflection sheet 23 is laid inside the chassis 14, the recesses 46 of the reflection sheet 23 and the chassis 14 conform to each other and mounting holes 32, 33 and the locking hole 45 are positioned so as to approach in the respective insertion holes 34, 35. Subsequently, an operation for mounting the lamp clips 18 to the chassis 14 is performed. The main body 27 is aligned with the recesses 46 of the chassis 14 and the reflection sheet 23, and the lamp clip 18 is pushed-in in a state where the mounting portion 30, 31 are conformed to the respective mounting holes 32, 33. Consequently, the main body 27 penetrates in the recess 46 and the mounting portions 30, 31 are inserted in the respective mounting holes 32, 33. At this point, the rear end part of the main body 27 in the sliding direction during mounting is arranged at an abutting position or a proximal position to the protruding peripheral wall part 46a of the recess 46 facing the rear in the sliding direction, and an interval corresponding to the slide amount is created between the front end part of the main body 27 in the sliding direction during mounting and the protruding peripheral wall part 46a of the recess 46 facing the front in the sliding direction. Subsequently, the main body 27 is arranged at an abutting position or a proximal position to the bottom part 46b of the recess 46, and from a state where the protrusions 30b, 31b protrude to the rear side of the chassis 14, the lamp clip 18 is slid in a protruding direction of the protrusions 30b, 31b (rightward as illustrated in FIG. 6). As a result, the protrusions 30b, 31b are arranged on a rear side of a front part in the sliding direction during mounting among the peripheral-edge parts of the mounting holes 32, 33.

During this process, a temporary elastic deformation of the protrusion 31b of the second mounting portion 31 occurs as the locking protrusion 44 runs to the rear surface of the chassis 14. Subsequently, when the lamp clip 18 is slid to a normal position, the protrusion 31b of the second mounting portion 31 is restored, the locking protrusion 44 enters the locking hole 45, and the locking surface of the locking protrusion 44 is locked by a peripheral surface of the locking hole 45. Accordingly, inadvertent movement of the lamp clip 18 in a detaching direction can be regulated. In this state, the peripheral-edge parts of the mounting holes 32, 33 are held between the protrusions 30b, 31b of the mounting portions 30, 31 and the main body 27, and the mounting holes 32, 33 are covered by the main body 27. As a result, it is now possible to prevent: visual recognition of the mounting holes 32, 33 as dark areas when an image is displayed on the liquid crystal panel 11 while lighting the cold cathode tube 17; leakage of light to the rear side through the mounting holes 32, 33; and infiltration of outside dust in the chassis 14 through the mounting holes 32, 33.

In the mounted state, the front end part of the main body 27 in the sliding direction during mounting is arranged at an abutting position or a proximal position to the protruding peripheral wall part 46a of the recess 46 facing the front in the sliding direction, while an interval corresponding to the slide amount is created between the rear end part of the main body 27 in the sliding direction during mounting and the protruding peripheral wall part 46a of the recess 46 facing the rear in the sliding direction. Meanwhile, the recess covering portion 47 and the auxiliary recess covering portion 48 jut more outward than the inner surface of the protruding peripheral wall part 46a of the recess 46 and abut the outside portion 23a of the recess 46 among the front surface of the reflection sheet 23. As a result, in combination with the main body 27 penetrating in the recess 46, the entire recess 46 is covered. Accordingly, the recess 46 can be prevented from being visually recognized as a dark area when an image is displayed on the liquid crystal panel 11 while lighting the cold cathode tube 17 and luminance unevenness of the backlight unit 12 can be prevented.

After mounting the lamp clip 18 as described above, each cold cathode tube 17 is mounted to each lamp gripping portion 28 and then the holder 20 is mounted. Subsequently, the diffusing plate 15a and the optical sheets 15b are laminated and set, the liquid crystal panel 11 is then mounted from the front side of the diffusing plate 15a and the optical sheets 15b, and the bezel 13 is further assembled to complete the assembly of the liquid crystal display device 10.

While the present embodiment adopts a configuration wherein recesses 46 in which the main body 27 penetrates are formed on the chassis 14 and the reflection sheet 23, the configuration is capable of achieving the following effects as compared to a hypothetical configuration wherein a recess or a hole is formed only in the reflection sheet and the main body is inserted in the recess or the hole. That is, while the reflection sheet 23 is undergoing recent progresses in thinning and the thickness dimension thereof has become extremely small, a predetermined thickness is retained for the chassis 14 for the interest of securing strength. As a result, there is a trend of an ever-increasing difference in thickness dimensions between the chassis 14 and the reflection sheet 23. Therefore, only a slight gain in depth can be achieved by forming a recess or a hole only in the reflection sheet and having the main body inserted the recess or the hole. In comparison, since the recess 46 is formed by having the chassis 14 protrude to the rear side in the present embodiment, a sufficient depth can be gained regardless of the thickness dimensions of the chassis 14 and the reflection sheet 23. Accordingly, since the interior space of the chassis 14 can be sufficiently expanded, a sufficient distance between the cold cathode tube 17 and the diffusing plate 15a and a sufficient thickness dimension (thickness) of the main body 27 can be secured by using the expanded space. In turn, the luminance unevenness prevention function of the backlight unit 12 can be enhanced and the strength of the main body 27 can be increased. As a result, thinning of the liquid crystal display device 10 and the backlight unit 12 can be favorably performed.

As described above, the illumination device according to the present embodiment includes: the cold cathode tube 17; the chassis 14 having the opening 14b (diffusing plate 15a, light-outputting surface) through which light is output; and the lamp clip 18 having the main body 27 mounted to the chassis 14 and the lamp gripping portion 28 provided on the main body 27 so as to grip the cold cathode tube 17. The chassis 14 has a recess 46 in which the main body 27 is inserted. With such a configuration, since at least a part of the main body 27 of the lamp clip 18 is inserted in the recess 46 formed on the chassis 14, a sufficient interval can be secured between the cold cathode tube 17 gripped by the lamp gripping portion 28 and the opening 14b in response to the penetration. Accordingly, luminance unevenness becomes less likely to occur. On the other hand, sufficient thickness and strength can be obtained for the part of the main body 27 that penetrates in the recess 46. Since the main body 27 is inserted in the recess 46, the strength of the chassis 14 can be maintained at a high level as compared to a hypothetical configuration in which a hole is formed on the chassis.

Furthermore, the lamp gripping portion 28 has a arm portion 36 connected to the main body 27. Due to such a configuration, since the arm portion 36 that is a part of the lamp gripping portion 28 is directly connected to the main body 27, the interval between the gripped cold cathode tube 17 and the opening 14b can be further widened by the arm portion 27.

Moreover, a part of a surface of the lamp gripping portion 28 opposing the cold cathode tube 17 is formed by a part of a front surface of the main body 27. Such a configuration enables the interval between the cold cathode tube 17 and the opening 14b to be further widened.

In addition, the recessed portion 38 is formed at a portion that constitutes a part of the surface of the lamp gripping portion 28 opposing the cold cathode tube 17 among the front surface of the main body 27. Such a configuration enables the interval between the cold cathode tube 17 and the opening 14b to be further widened.

Furthermore, at least the part of the main body 27 on which the lamp gripping portion 28 is provided is inserted in the recess 46. When the arm portion 36 is directly connected to the main body 27, a holding force for the cold cathode tube 17 tends to become proportional to the strength of the portion where the lamp gripping portion 28 is provided among the main body 27. However, with the configuration described above, the strength of the portion where the lamp gripping portion 28 is provided among the main body 27 can be increased. As a result, the holding force for the cold cathode tube 17 can be increased.

Moreover, supporting protrusions 39 to 41 for supporting the cold cathode tube 17 are provided on a surface of the lamp gripping portion 28 opposing the cold cathode tube 17. With such a configuration, when the cold cathode tube 17 is gripped by the lamp gripping portion 28, the cold cathode tube 17 is to be supported by the supporting protrusions 39 to 41 and, at the same time, a gap G is created between the cold cathode tube 17 and the surface of the lamp gripping portion 28 opposing the cold cathode tube 17. Light emitted from the cold cathode tube 17 is efficiently radiated to the outside through the gap G. As a result, luminance unevenness can be more favorably prevented.

In addition, the first supporting protrusion 39 is provided at a portion having the maximum distance from the opening 14b among the surface of the lamp gripping portion 28 opposing the cold cathode tube 17. Such a configuration enhances an extraction efficiency of light emitted to the side opposite to the opening 14b among light emitted from the cold cathode tube 17. Accordingly, luminance unevenness can be more favorably prevented.

Furthermore, the lamp gripping portion 28 includes a pair of arm portions 36 rising from the main body 27, wherein the supporting protrusions 39 to 41 are respectively provided on the pair of arm portions 36 and at a portion held between the pair of arm portions 36 among the lamp gripping portion 28 and are capable of providing three-point support of the cold cathode tube 17. With such a configuration, since gaps G are respectively created between the supporting protrusions 39 to 41 that provide three-point support of the cold cathode tube 17, the extraction efficiency of light can be further enhanced.

Moreover, the recess 46 is formed with a size that allows penetration by the entire main body 27. With such a configuration, since sufficient thickness can be obtained for the entire main body 27, the main body 27 can be strengthened more effectively.

In addition, a plurality of lamp gripping portions 28 are provided side by side on the main body 27. Such a configuration is suitable for gripping a plurality of cold cathode tubes 17.

Furthermore, the reflection sheet 23 that has a reflecting surface for reflecting light to the side of the opening 14b is provided on the front surface of the chassis 14, and the main body 27 is formed such that a front surface thereof is flush with the outside portion 23a of the recess 46 among the front surface of the reflection sheet 23. With such a configuration, the main body 27 becomes less likely to be visually-recognized as a dark area compared to a hypothetical configuration where the front surface of the main body retreats further away from the opening than the reflecting surface. As a result, luminance unevenness can be effectively prevented.

Moreover, mounting holes 32, 33 are provided at the recess 46 among the chassis 14, while mounting portions 30, 31 that are to be inserted in the mounting holes 32, 33 and that are capable of holding peripheral-edge parts of the mounting holes 32, 33 between the main body 27 and themselves are provided on the main body 27. With such a configuration, since the mounting holes 32, 33 can be covered by the portion that penetrates the recess 46 among the main body 27, the mounting holes 32, 33 can be prevented from being visually-recognized as dark areas and leakage of light from the mounting holes 32, 33 can be prevented. In addition, infiltration of dust from the mounting holes 32, 33 can be prevented.

In addition, the mounting portions 30, 31 include base portions 30a, 31a protruding from the main body 27 to the side of the chassis 14 and protrusions 30b, 31b protruding from the base portions 30a, 31a in a direction along the main body 27, whereby the protrusions 30b, 31b are configured so as to be capable of holding peripheral-edge parts of the mounting holes 32, 33 between the main body 27 and themselves by being slid in a direction along the main body 27 from a state where the protrusions 30b, 31b are inserted in the mounting holes 32, 33. Such a configuration causes the lamp clip 18 to become suitable for mounting by sliding the lamp clip 18 towards the chassis 14.

Furthermore, recess covering portions 47, 48 that protrude along a sliding direction with respect to the chassis 14 and that are capable of covering the recess 46 are provided on the main body 27. With such a configuration, when a lamp clip 18 is mounted to the chassis 17 by a sliding motion, a portion not covered by the main body 27 among the recess 46 can be covered by the recess covering portions 47, 48. Accordingly, since the recess 46 is not exposed to the side of the opening 14b, the recess 46 is less likely to be recognized as a dark area. This contributes to reducing luminance unevenness.

Moreover, the diffusing plate 15a and the optical sheet 15b that are light transmissive are arranged on the opening 14b of the chassis 14. With such a configuration, light emitted from the cold cathode tube 17 is transmitted and outputted through the diffusing plate 15a and the optical sheet 15b arranged at the opening 14b. This contributes to reducing luminance.

Moreover, the present embodiment is configured such that: the cold cathode tube 17 used has a tube diameter of 4.0 mm; the distance between the cold cathode tube 17 and the reflection sheet 23 is set to 0.8 mm; the distance between adjacent cold cathode tubes 17 is set to 16.4 mm; and the distance between the cold cathode tube 17 and the diffusing plate 15a is set to 2.7 mm. As shown, thinning is applied between the components in the backlight unit 12. In particular, the distance between the cold cathode tube 17 and the diffusing plate 15a and the distance between the cold cathode tube 17 and the reflection sheet 23 have been reduced. Due to such thinning of the backlight unit 12, a thickness of the liquid crystal display device 10 (i.e., a thickness from a front surface of the liquid crystal panel 11 to a rear surface of the backlight unit 12) of 16 mm and a thickness of the television receiver apparatus TV (i.e., a thickness from a front surface of the front-side cabinet Ca to a rear surface of the rear-side cabinet Cb) of 34 mm are realized. As a result, a thin television receiver apparatus can be provided.

### Second Embodiment

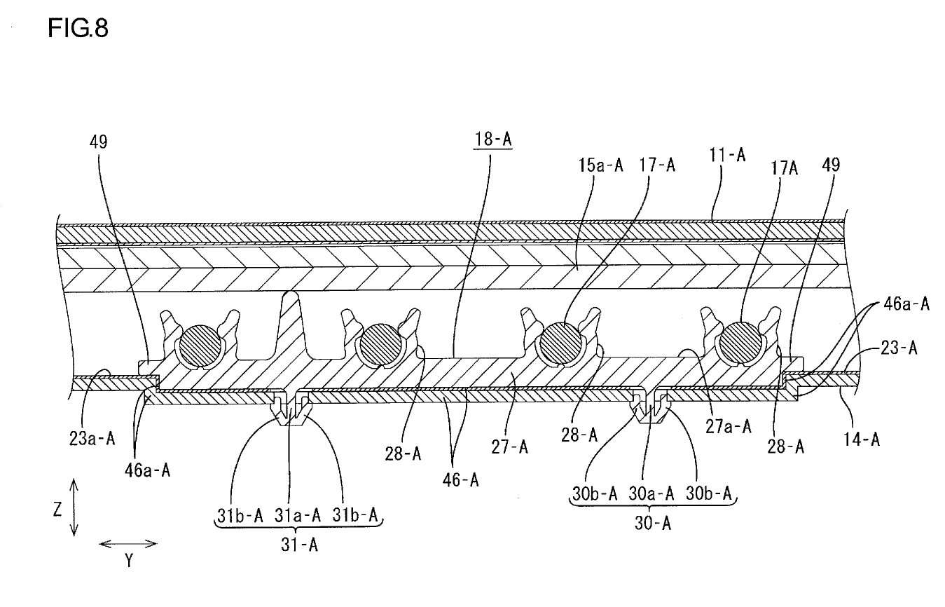

A second embodiment of the present invention will be described with reference to FIG. 8. In the present second embodiment, a configuration will be presented where structures of mounting portions 30-A, 31-A and mounting holes 32-A, 33-A and a shape of a recess 46-A have been changed. Moreover, in the present second embodiment, parts with the same name as in the first embodiment described above will be denoted using the same reference characters with the addition of a suffix-A, and redundant descriptions on configurations, operations, and effects will be omitted.

As illustrated in FIG. 8, the mounting portions 30-A, 31-A include base portions 30a-A, 31a-A that protrude from a rear surface of a main body 27-A and pairs of protrusions 30b-A, 31b-A that are folded back to the side of the main body 27-A from tips of the base portions 30a-A, 31a-A and that oppose the base portions 30a-A, 31a-A. The protrusions 30b-A, 31b-A-F are formed as cantilevered shapes and arranged to be elastically deformable so as to approach the side of the base portions 30a-A, 31a-A. Stepped locking surfaces are formed on tips of the protrusions 30b-A to 31b-A-F. The mounting holes 32-A, 33-A of a chassis 14-A are arranged so as to have diameters sized approximately equal to intervals between locking surfaces of the protrusions 30b-A, 31b-A.

Meanwhile, the size of the recess 46-A as seen in plan view is set approximately equal to the main body 27-A. More specifically, a short-side dimension and a long-side dimension of the recess 46-A are the same or slightly greater than a short-side dimension and a long-side dimension of the main body 27-A. Accordingly, the main body 27-A is inserted in the recess 46-A with almost no gap therebetween, and opposing peripheral surfaces are to abut each other in a mounted state. In addition, a recess covering portion 49 that juts more outward than an inner surface of a protruding peripheral wall part 46a-A of the recess 46-A is provided around the entire periphery on an outer end part of the main body 27-A. The recess covering portion 49 has a frame-shape that surrounds the main body 27-A and abuts an outside part 23a-A of the recess 46-A among a front surface of the reflection sheet 23-A. Even when a gap is created during a mounted state between the outer surface of the main body 27-A and the inner surface of the protruding peripheral wall part 46a-A of the recess 46-A due to the influence of dimensional tolerance of a lamp clip 18-A or the like, the recess covering portion 49 is capable of covering such a gap. Otherwise, for example, when a gap is created between the recess 46-A and the main body 27-A as a result of setting the size of the recess 46-A so as to be greater than the size of the main body 27-A and loosely fitting the main body 27-A in the recess 46-A for the purpose of reducing frictional resistance generated between the main body 27-A and the main body 27-A during mounting, the gap can be covered by the recess covering portion 49 described above. In addition, the front-side surface of the recess covering portion 49 is approximately flush with an outside portion 27a-A of each lamp gripping portion 28-A among the front-side surface of the main body 27-A.

When the lamp clip 18-A is pushed against the chassis 14-A from a front side along the Z-axis direction, the main body 27-A penetrates in the recess 46-A, the mounting portions 30-A, 31-A are inserted in the mounting holes 32-A, 33-A and the protrusions 30b-A, 31b-A become temporarily elastically deformed. Subsequently, when the lamp clip 18-A is pushed to a correct depth, the mounting portions 30-A, 31-A protrude to a rear side of the chassis 14-A, the protrusions 30b-A, 31b-A-F are restored, and the locking surfaces are locked from the rear side to peripheral-edge parts of the mounting holes 32-A, 33-A of the chassis 14-A. Accordingly, the lamp clip 18-A is held in a mounted state with respect to the chassis 14-A. In this state, since the entire area of the recess 46-A is covered by the main body 27-A and the recess covering portion 49 and is not exposed to a side of a diffusing plate 15a-A, the recess 46-A can be prevented from being visually recognized as a dark area when lighting the cold cathode tube 17-A and displaying an image on the liquid crystal panel 11-A. Furthermore, the mounting holes 32-A, 33-A are covered by the main body 27-A.

As described above, according to the present embodiment, the mounting portions 30-A, 31-A include base portions 30a-A, 31a-A protruding from the main body 27 to the side of the chassis 14-A and protrusions 30b-A, 31b-A protruding from the base portions 30a-A, 31a-A in a direction along the main body 27-A, whereby the protrusions 30b-A, 31b-A are configured so as to be able to hold the peripheral-edge parts of the mounting holes 32-A, 33-A between the main body 27-A and themselves when inserted in the respective mounting holes 32-A, 33-A. Such a configuration causes the lamp clip 18-A to become suitable for mounting by pushing the lamp clip 18-A against the chassis 14-A.

In addition, the recess 46-A is formed with approximately the same size as the main body 27-A. Such a configuration enables the recess 46-A to be covered by the main body 27-A. Accordingly, since the recess 46-A is not exposed to the side of the diffusing plate 15a-A (opening), the recess 46-A is less likely to be recognized as a dark area. This contributes to reducing luminance unevenness.

### Third Embodiment

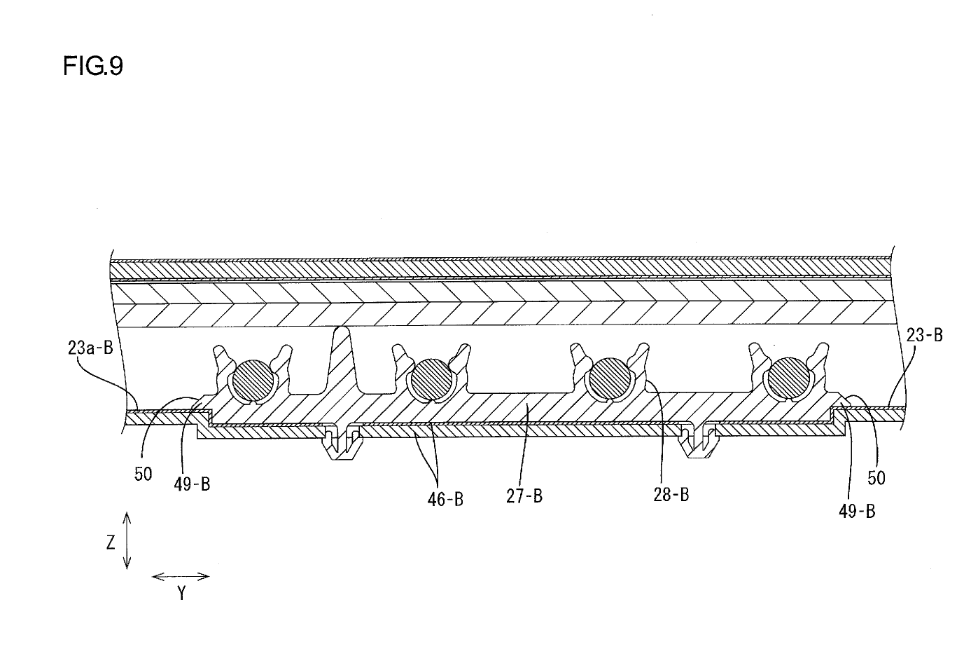

A third embodiment of the present invention will be described with reference to FIG. 9. In the present third embodiment, a configuration will be presented where the shape of a recess covering portion 49-B has been changed from the second embodiment described above. Moreover, in the present third embodiment, parts with the same name as in the second embodiment described above will be denoted using the same reference characters with the addition of a suffix-B, and redundant descriptions on configurations, operations, and effects will be omitted.

As illustrated in FIG. 9, the recess covering portion 49-B has a frame-shape that surrounds a main body 27-B and constitutes an outer side part of the main body 27-B. In addition, an inclined surface 50 having a tapered shape is formed on a front-side surface of the recess covering portion 49-B. The inclined surface 50 has a gradient (down grade) that progressively becomes lower the further towards an outer edge side of the recess covering portion 49-B. In other words, the recess covering portion 49-B forms a tapered-shape towards the outer edge side while the inclined surface 50 has a fan shape that spreads towards the outer edge side. In this case, a vertical displacement is created between an outside portion 27a-B of each lamp gripping portion 28-B among a front-side surface of the main body 27-B and an outside portion 23a-B of a recess 46-B among a front surface of a reflection sheet 23-B. However, since the recess covering portion 49-B that constitutes the outer side part of the main body 27-B is formed such that the vertical displacement progressively decreases the further towards the outer edge side as described above, visual recognition of the main body 27-B and the recess covering portion 49-B as dark areas due to the vertical displacement can be suppressed.

As described above, according to the present embodiment, the reflection sheet 23-B having a reflecting surface that reflects light to the side of the diffusing plate 15a-B (opening) is provided on the surface of the chassis 14-B. In addition, when a vertical displacement is created between the outside portion 27a-B of the lamp gripping portion 28-B among the front surface of the main body 27-B and the outside portion 23a-B of the recess 46-B among the front surface of the reflection sheet 23-B, at least the outer side part among the front surface of the main body 27-B is formed such that the vertical displacement between the outside portion 23a-B of the recess 46-B among the front surface of the reflection sheet 23-B progressively decreases the further towards the outer edge side. Such a configuration can reduce luminance unevenness that may occur due to a vertical displacement.

### Fourth Embodiment

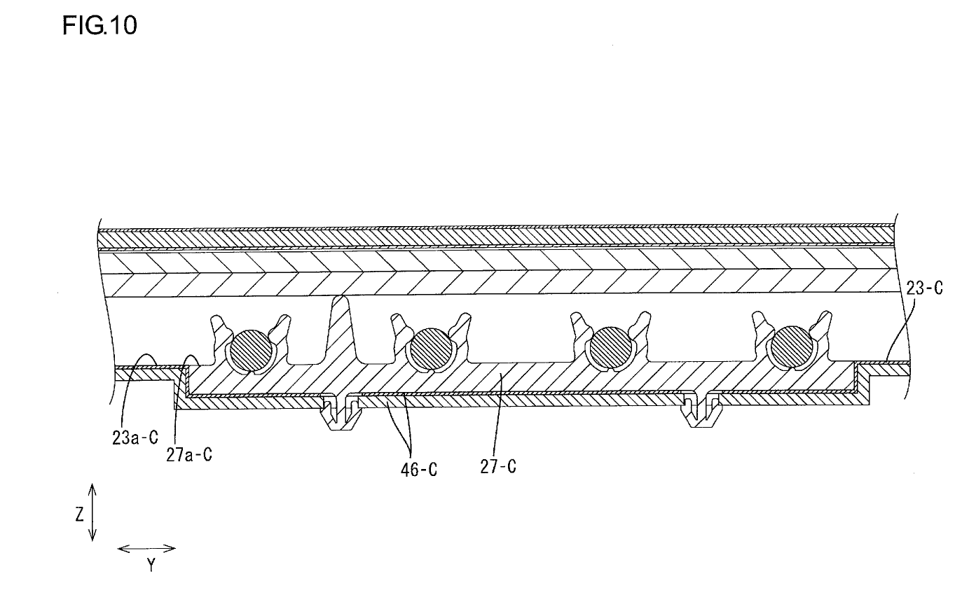

A fourth embodiment of the present invention will be described with reference to FIG. 10. In the present fourth embodiment, a configuration will be presented where the recess covering portion 49-B has been omitted and the depth dimension of a recess 46-C has been changed from the second embodiment described above. Moreover, in the present fourth embodiment, parts with the same name as in the second embodiment described above will be denoted using the same reference characters with the addition of a suffix-C, and redundant descriptions on configurations, operations, and effects will be omitted.

As illustrated in FIG. 10, the depth dimension of the recess 46-C is set approximately the same as a thickness dimension of a main body 27-C. Therefore, when the main body 27-C penetrates in the recess 46-C, the entire thickness range (entire height range) of the main body 27-C penetrates in the recess 46-C, and an outside portion 27a-C of each lamp gripping portion 28-C among a front-side surface of the main body 27-C (a front surface of the main body 27-C) becomes approximately flush with an outside portion 23a-C (reflecting surface) of the recess 46-C among a front surface of a reflection sheet 23-C. As a result, the creation of a vertical displacement between the outside portion 27a-C and the outside portion 23a-C can be avoided. Accordingly, the main body 27-C is less likely to be recognized as a dark area. This contributes to reducing luminance unevenness.

As described above, according to the present embodiment, in the main body 27-C, the outside portion 27a-C of each lamp gripping portion 28-C among the front surface is formed so as to be approximately flush with the outside portion 23a-C of the recess 46-C among the front surface of the reflection sheet 23-C. Due to such a configuration, since the creation of a vertical displacement between the outside portion 27a-C of each lamp gripping portion 28-C among the front surface of the main body 27-C and the outside portion 23a-C of the recess 46-C among the front surface of the reflection sheet 23-C can be avoided, luminance unevenness can be prevented more effectively.

### Fifth Embodiment

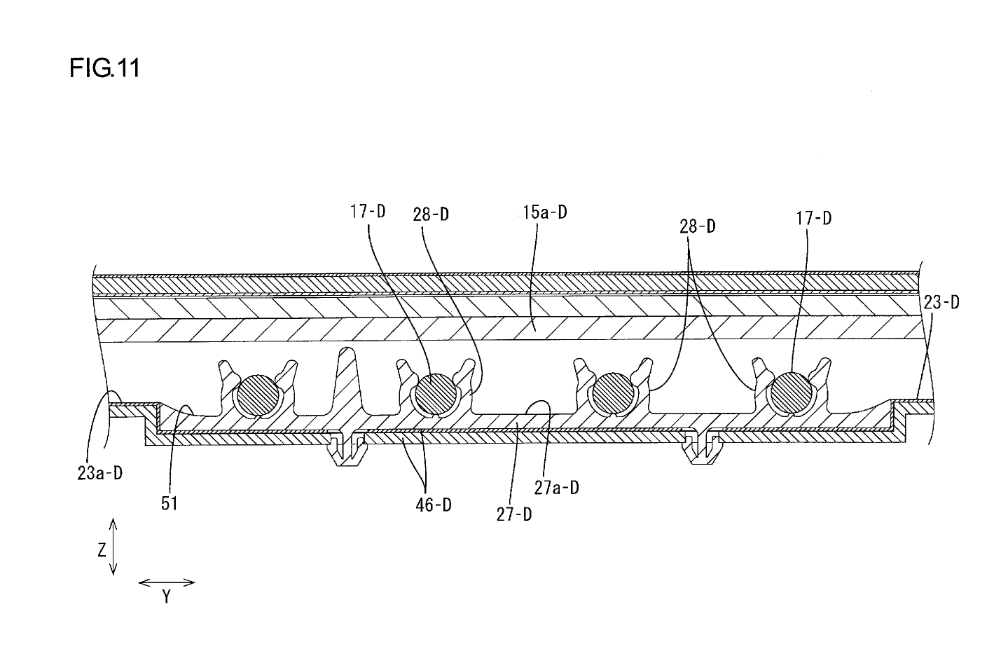

A fifth embodiment of the present invention will be described with reference to FIG. 11. In the present fifth embodiment, a configuration will be presented where a shape of a front-side surface of a main body 27-D has been changed from the fourth embodiment described above. Moreover, in the present fifth embodiment, parts with the same name as in the fourth embodiment described above will be denoted using the same reference characters with the addition of a suffix-D, and redundant descriptions on configurations, operations, and effects will be omitted.

As illustrated in FIG. 11, an outside portion 27a-D of each lamp gripping portion 28-D among the front-side surface of the main body 27-D is arranged lower than an outside portion 23a-D of a recess 46-D among a front surface of a reflection sheet 23-D or, in other words, arranged at a position that retreats in a direction receding from a diffusing plate 15a-D (a position at which the distance from the diffusing plate 15a-D increases). As a result, a vertical displacement portion exists between the outside portion 27a-D and the outside portion 23a-D. Meanwhile, a curved surface 51 for reducing the vertical displacement is formed on an outer side part of the main body 27-D. The curved surface 51 has a gradient (up grade) that progressively becomes higher the further towards the outer edge side of the main body 27-D. In other words, the outer side part of the main body 27-D is formed so as to become wider the further towards the outer edge side. Accordingly, the outer side part among the main body 27-D is arranged at approximately the same height position as the outside portion 23a-D of the recess 46-D among the front surface of the reflection sheet 23-D.

As described above, since the outer side part of the main body 27-D is formed such that a vertical displacement between the outside portion 23a-D of the recess 46-D among the front surface of the reflection sheet 23-D progressively becomes smaller the further towards the outer edge side, visual recognition of the main body 27-B as a dark area due to the vertical displacement can be suppressed. In addition, since the distance between a cold cathode tube 17-D and the diffusing plate 15a-D can be further increased by setting the outside portion 27a-D of each lamp gripping portion 28-D among the front-side surface of the main body 27-D lower than the outside portion 23a-D of the recess 46-D among the front surface of the reflection sheet 23-D, luminance unevenness can be favorably prevented.

As described above, according to the present embodiment, the reflection sheet 23-D having a reflecting surface that reflects light towards the side of the diffusing plate 15a-D (opening) is provided on the front surface of a chassis 14-D, and the outside portion 27a-D of each lamp gripping portion 28-D among the front-side surface of the main body 27-D is formed so as to retreat in a direction receding from the diffusing plate 15a-D (opening) as compared to the outside portion 23a-D of the recess 46-D among the front surface of the reflection sheet 23-D. Such a configuration enables the interval between the cold cathode tube 17-D and the diffusing plate 15a-D (opening) to be further widened.

In addition, when a vertical displacement is created between the outside portion 27a-D of each lamp gripping portion 28-D among the front surface of the main body 27-D and the outside portion 23a-D of the recess 46-D among the front surface of the reflection sheet 23-D, at least the outer side part of the front surface of the main body 27-D is formed such that the vertical displacement between the outside portion 23a-D of the recess 46-D among the front surface of the reflection sheet 23-D progressively becomes smaller the further towards the outer edge side. Such a configuration can reduce luminance unevenness that may occur due to a vertical displacement.

### Sixth Embodiment

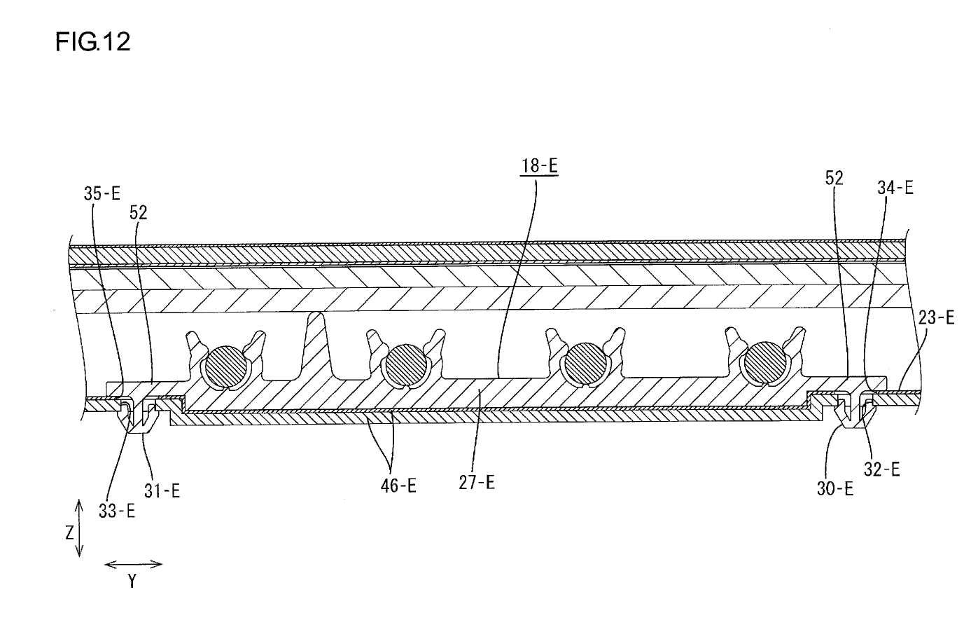

A sixth embodiment of the present invention will be described with reference to FIG. 12. In the present sixth embodiment, a configuration will be presented where arrangements of mounting portions 30-E, 31-E, mounting holes 32-E, 33-E, and insertion holes 34-E, 35-E have been changed from the second embodiment described above. Moreover, in the present sixth embodiment, parts with the same names as in the second embodiment described above will be denoted using the same reference characters with the addition of a suffix -E, and redundant descriptions on configurations, operations, and effects will be omitted.

As illustrated in FIG. 12, the mounting holes 32-E, 33-E are formed at an outward portion than a recess 46-E of a chassis 14-E. Similarly, the insertion holes 34-E, 35-E are formed at an outward portion than the recess 46-E of a reflection sheet 23-E. Meanwhile, a pair of jutting portions 52 is provided that extend along a long-side direction from the long-side end parts of a main body 27-E of a lamp clip 18-E. mounting portions 30-E, 31-E that is inserted in the mounting holes 32-E, 33-E described above are provided at the jutting portions 52. The jutting portions 52 are formed with sizes capable of covering the mounting holes 32-E, 33-E.

### Seventh Embodiment

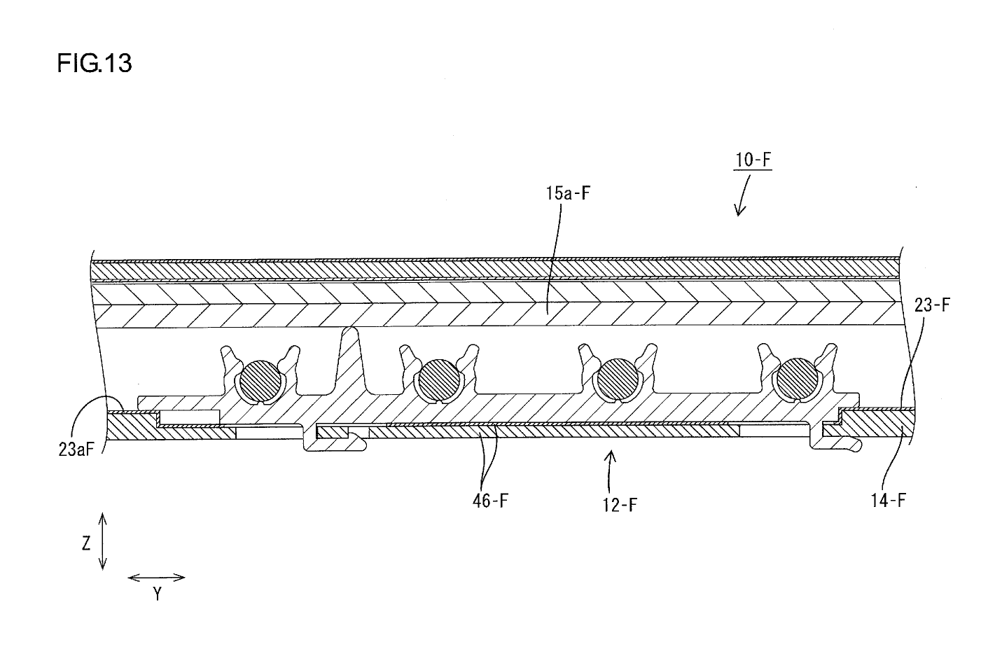

A seventh embodiment of the present invention will be described with reference to FIG. 13. In the present seventh embodiment, a configuration will be presented where the shape of a recess 46-F has been changed from the first embodiment. Moreover, in the present seventh embodiment, parts with the same names as in the first embodiment described above will be denoted using the same reference characters with the addition of a suffix -F, and redundant descriptions on configurations, operations, and effects will be omitted.

As illustrated in FIG. 13, the recess 46-F is formed by depressing only a front-side surface (a surface on the side of a diffusing plate 15a-F) of a chassis 14-F. No recess or protrusion is to be formed on a rear-side surface (a surface on an opposite side to the diffusing plate 15a-F) of the chassis 14-F. Therefore, it can be described that among the front-side surface of the chassis 14-F, distances to the diffusing plate 15a-F change between the recess 46-F and a peripheral part thereof (an outside portion 23a-F). In contrast, on the rear-side surface of the chassis 14-F, the distance to the diffusing plate 15a-F is constant (invariant) between the recess 46-F and the peripheral part thereof and a portion corresponding to the recess 46-F does not protrude to the rear side. Therefore, compared to the first embodiment, thinning of a liquid crystal display device 10-F and a backlight unit 12-F can be achieved by just the amount that the recess 46-F does not protrude to the rear side. The recess 46-F can be formed by shaving the front-side surface of the chassis 14-F or the like.

As described above, according to the present embodiment, while distances to the diffusing plate 15a-F (opening) differ between the recess 46-F and the peripheral part thereof on the surface on the side of the diffusing plate 15a-F (opening) of the chassis 14-F, the distance to the diffusing plate 15a-F (opening) is constant between the recess 46-F and the peripheral part thereof on the surface on the opposite side of the diffusing plate 15a-F (opening) of the chassis 14-F. With such a configuration, overall thinning can be achieved as compared to a hypothetical configuration where the surface of the recess of the chassis on the side opposite to the diffusing plate protrudes in a direction receding from the diffusing plate as compared to the peripheral part of the recess.

### Eighth Embodiment

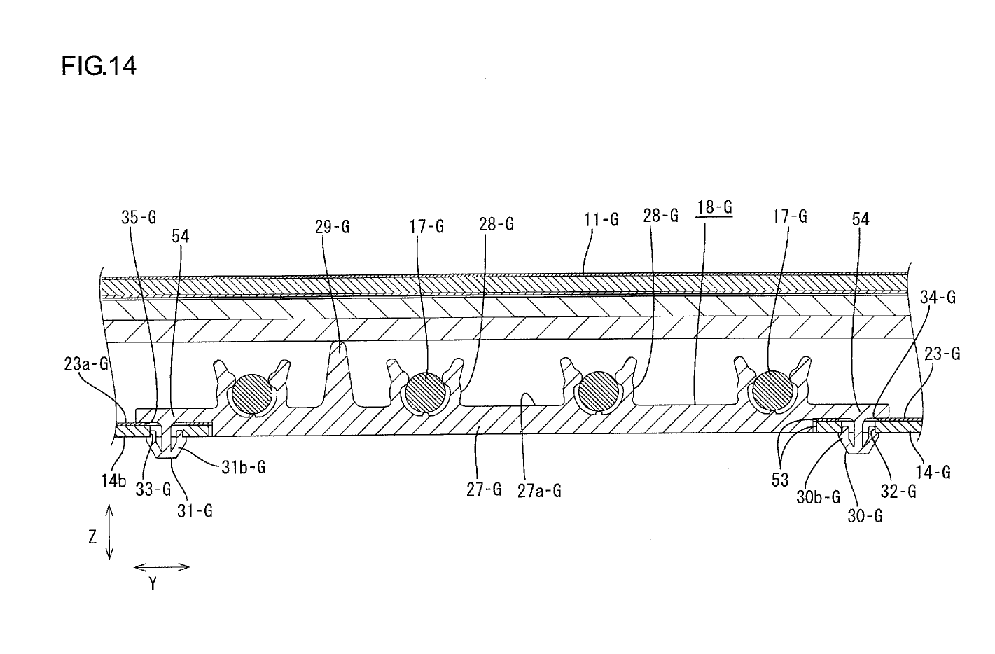

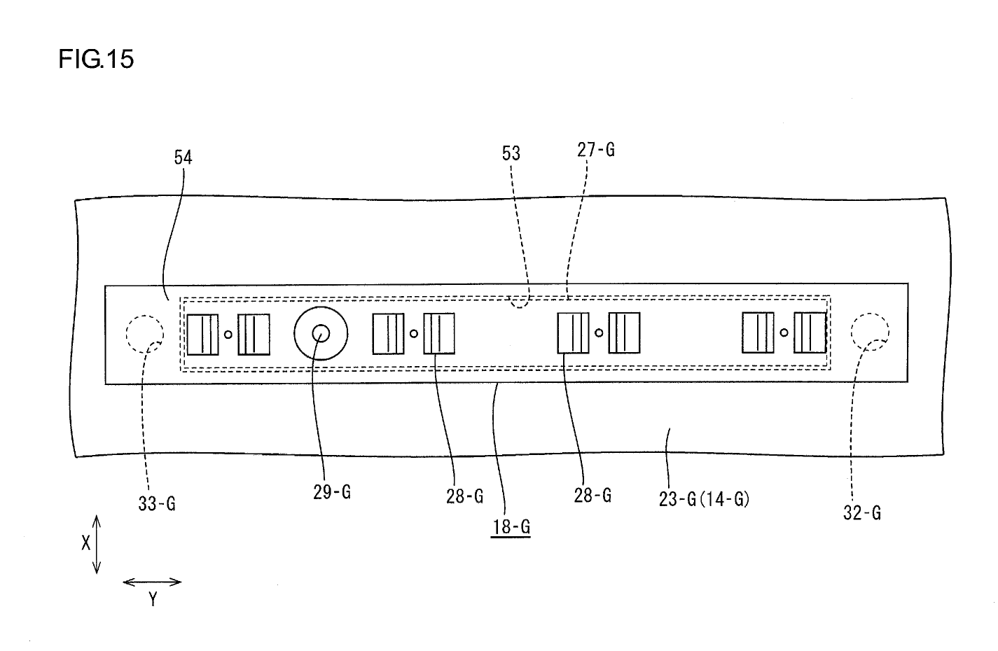

An eighth embodiment of the present invention will be described with reference to FIG. 14 or 15. In the present eighth embodiment, a configuration will be presented where a hole 53 in which a main body 27-G penetrates is formed on a chassis 14-G. Moreover, in the present eighth embodiment, parts with the same name as in the first embodiment described above will be denoted using the same reference characters with the addition of a suffix -G, and redundant descriptions on configurations, operations, and effects will be omitted.

As illustrated in FIG. 14, the chassis 14-G and a reflection sheet 23-G have the holes 53 in which the main body 27-G of the lamp clip 18-G is inserted. The holes 53 are located at a predetermined mounting position. The holes 53 runs through the bottom plate of the chassis 14-G and the reflection sheet 23-G in a thickness direction. An inside of the hole 53 is a housing space for retaining the main body 27-G of the lamp clip 18-G.

As illustrated in FIG. 15, the hole 53 is formed rectangular as seen in plan view so as to conform to the main body 27-G. The size as seen in plan view of the hole 53 is set larger than the main body 27-G. Therefore, the hole 53 is capable of receiving the entire main body 27-G. Specifically, a short-side dimension and a long-side dimension of the hole 53 are set lightly greater than a short-side dimension and a long-side dimension of the main body 27-G.

An jutting portion 54 that juts outward than an inner surface of the hole 53 is provided around an entire periphery of an outer end part of the main body 27-G. Therefore, the hole 53 can be covered by the jutting portion 54. The jutting portion 54 forms a frame shape that encloses the main body 27-G. The jutting portion 54 is provided at a front-side part in a thickness direction of the main body 27-G. Therefore, while a front-side surface of the jutting portion 54 is flush with an outside portion 27a-G of each lamp gripping portion 28-G among the front surface of the main body 27-G, a vertical displacement is created between a rear-side surface of the jutting portion 54 and a rear-side surface 27b of the main body 27-G. Mounting portions 30-G, 31-G are provided on the rear-side surface of the jutting portion 54. Since the structure of the mounting portions 30-G, 31-G is similar to those described in the second to sixth embodiments, a redundant description thereof will be omitted. Mounting holes 32-G, 33-G are provided on an outside portion of the hole 53 among the chassis 14-G so as to correspond to the mounting portions 30-G, 31-G. The jutting portion 54 is formed with a size capable of covering the mounting holes 32-G, 33-G.

Moreover, insertion holes 34-G, 35-G are formed on an outside portion of the hole 53 of the reflection sheet 23-G so as to correspond to the mounting holes 32-G, 33-G.

When mounting the lamp clip 18-G to the chassis 14-G, a worker grips a supporting pin 29-G that protrudes frontward from the main body 27-G, and while aligning the main body 27-G to the hole 53, pushes in the lamp clip 18-G in the Z-axis direction from the front-side of the chassis 14-G. Subsequently, when the mounting portions 30-G, 31-G are inserted in corresponding mounting holes 32-G, 33-G and reach a correct depth, protrusions 30b-G, 31b-G lock to peripheral-edge parts of the mounting holes 32-G, 33-G from a rear side to retain a mounted state of the lamp clip 18-G on the chassis 14-G. In the mounted state, while the main body 27-G has penetrated in the hole 53, a slight gap is created between the outer surface of the main body 27-G and a peripheral surface of the hole 53. However, since the jutting portion 54 that juts out from the outer surface of the main body 27-G reaches more outward than the peripheral surface of the hole 53 and abuts an outside portion 23a-G of the hole 53 among the front surface of the reflection sheet 23-G, the entire area of the hole 53 is covered from the front side by the jutting portion 54. In addition, the rear-side surface of the main body 27-G is flush with a rear-side surface of the chassis 14-G.

Meanwhile, the entire areas of the mounting holes 32-G, 33-G are covered from the front side by a portion where the mounting portions 30-G, 31-G are provided among the jutting portion 54. As a result, it is now possible to prevent: visual recognition of the hole 53 and the mounting holes 32-G, 33-G as dark areas when an image is displayed on a liquid crystal panel 11-G while lighting a cold cathode tube 17-G; leakage of light to the rear side through the hole 53 and the mounting holes 32-G, 33-G; and infiltration of outside dust in the chassis 14-G through the hole 53 and the mounting holes 32-G, 33-G.

As described above, according to the present embodiment, the hole 53 in which at least a part of the main body 27-G penetrates is formed on the chassis 14-G. With such a configuration, overall thinning can be achieved as compared to a hypothetical configuration where a recess 46 protruding in a direction receding from a diffusing plate 15a (opening) is formed on a chassis 14 as is the case in the first embodiment.

In addition, the lamp clip 18-G is configured so as to be mounted on the chassis 14-G from a side of the diffusing plate 15a-G (opening). Such a configuration provides excellent operability for mounting to the chassis 14-G.

Furthermore, the light transmissive diffusing plate 15a-G is arranged at the opening of the chassis 14-G, and the supporting pin 29-G that protrudes further towards the side of the diffusing plate 15a-G than the lamp gripping portion 28-G and that is capable of supporting the diffusing plate 15a-G is provided on the main body 27-G. With such a configuration, the diffusing plate 15a-G can be supported by the supporting pin 29-G. In addition, since a worker can perform a mounting operation of the lamp clip 18-G to the chassis 14-G while gripping the supporting pin 29-G, superior operability is achieved.

Moreover, the jutting portion 54 that juts outward than the peripheral surface of the hole 53 and that is capable of covering the hole 53 is provided on the main body 27-G. Such a configuration enables the hole 53 to be covered by the jutting portion 54 of the main body 27-G to be mounted from the side of the diffusing plate 15a-G (opening). Since the hole 53 is not exposed to the side of the diffusing plate 15a-G (opening), the hole 53 is less likely to be recognized as a dark area. This contributes to reducing luminance unevenness. Further, light does not pass through the hole 53. Still further, dust does not enter through the hole 53.

In addition, while mounting holes 32-G, 33-G are provided on the chassis 14-G, mounting portions 30-G, 31-G that are to be inserted in the mounting holes 32-G, 33-G and that are capable of holding peripheral-edge parts of the mounting holes 32-G, 33-G between the main body 27-G and themselves are provided on the main body 27-G, and the jutting portion 54 that protrudes along the chassis 14-G and that is capable of covering the mounting holes 32-G, 33-G are provided on the main body 27-G. With such a configuration, since the mounting holes 32-G, 33-G can be covered by the jutting portion 54, the mounting holes 32-G, 33-G is less likely to be recognized as dark areas. Light does not pass through the mounting holes 32-G, 33-G. Moreover, dust does not enter through the mounting holes 32-G, 33-G.

### Ninth Embodiment

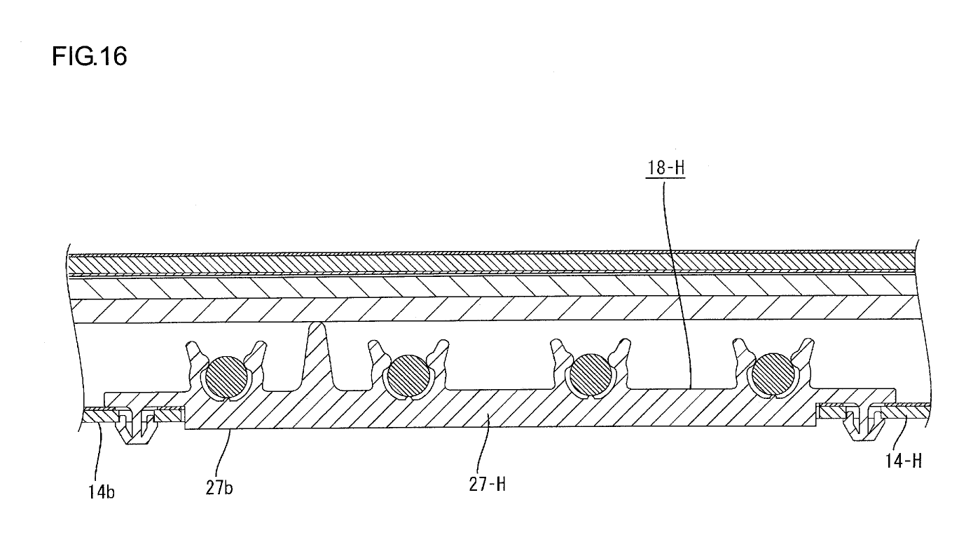

A ninth embodiment of the present invention will be described with reference to FIG. 16. In the present ninth embodiment, a configuration will be presented where a thickness dimension of a main body 27-H has been changed from the eighth embodiment described above. Moreover, in the present ninth embodiment, parts with the same name as in the eighth embodiment described above will be denoted using the same reference characters with the addition of a suffix-H, and redundant descriptions on configurations, operations, and effects will be omitted.

As illustrated in FIG. 16, the main body 27-H has a thickness dimension that allows a rear-side surface 27b of the main body 27-H to protrude more rearward than a rear-side surface 14b of a chassis 14-H in a state where a lamp clip 18-H is mounted to the chassis 14-H. Accordingly, compared to the eighth embodiment, the thickness of the main body 27-H can be increased and the strength of the main body 27-H can be further enhanced.

As described above, according to the present embodiment, a part of the main body 27-H that is inserted in a hole 53-H is formed so as to protrude from a surface of the chassis 14-H on an opposite side to the side of a diffusing plate 15a-H (opening). With such a configuration, the thickness of the main body 27-H can be increased and the strength of the main body 27-H can be enhanced.

<Tenth Embodiment>

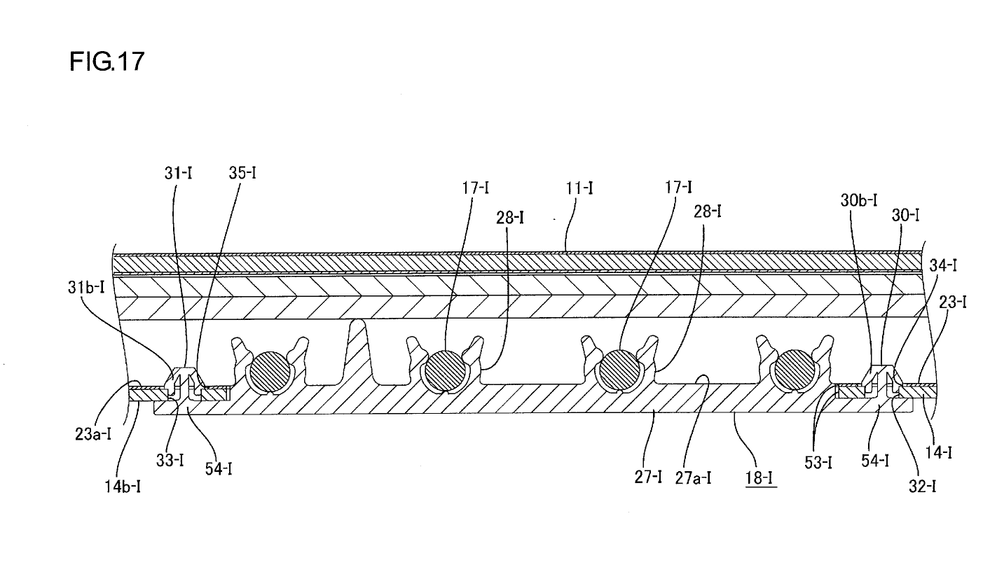

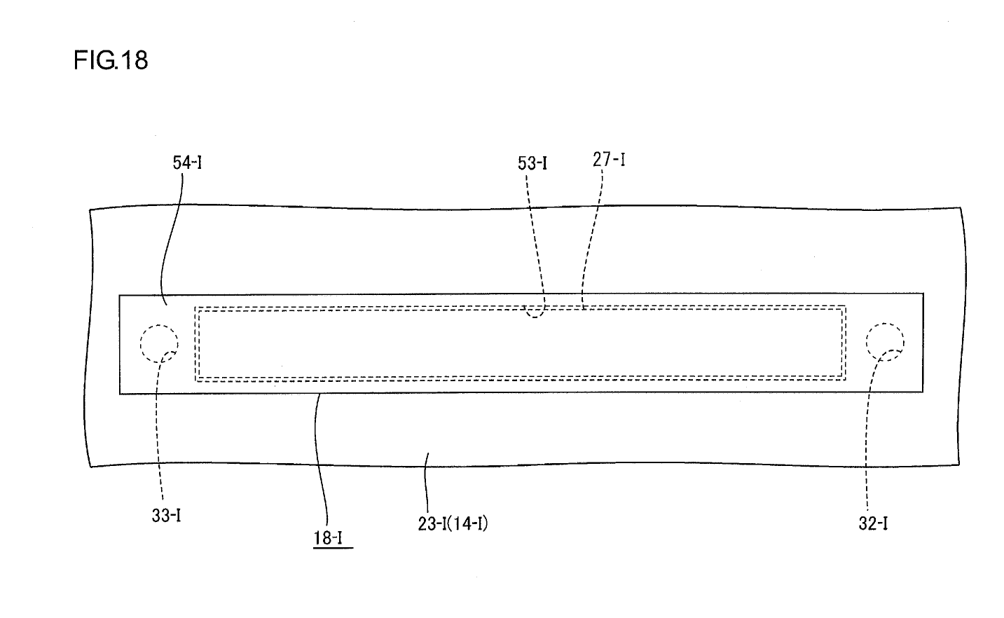

A tenth embodiment of the present invention will be described with reference to FIG. 17 or 18. In the present tenth embodiment, a configuration will be presented in which a mounting direction of a lamp clip 18-I to a chassis 14-I has been changed from the eighth embodiment described above. Moreover, in the present tenth embodiment, parts with the same name as in the eighth embodiment described above will be denoted using the same reference characters with the addition of a suffix-I, and redundant descriptions on configurations, operations, and effects will be omitted.

As illustrated in FIGS. 17 and 18, the lamp clip 18-I is configured so as to be mounted to the chassis 14-I from a rear side. A jutting portion 54-I of the lamp clip 18-I is provided on a rear-side part with respect to a thickness direction among an outer end part of a main body 27-I. Therefore, while a rear-side surface of the jutting portion 54-I is flush with the rear-side surface of the main body 27-I, a vertical displacement is created between a front-side surface of the jutting portion 54-I and an outside part 27a-I of each lamp gripping portion 28-I among the main body 27-I. Mounting portions 30-I, 31-I are provided on the front-side surface of the jutting portion 54-I and inserted in mounting holes 32-I, 33-I of the chassis 14-I outside an area in which a hole 53-I is provided.

When mounting the lamp clip 18-I to the chassis 14-I, the lamp clip 18-I is pushed in the Z-axis direction from the rear side of the chassis 14-I while aligning the main body 27-I to the hole 53-I. Subsequently, when the mounting portions 30-I, 31-I are inserted in corresponding mounting holes 32-I, 33-I and reach a correct depth, protrusions 30b-I, 31b-I lock to peripheral-edge parts of the mounting holes 32-I, 33-I from a front side to retain a mounted state of the lamp clip 18-I to the chassis 14-I. In the mounted state, while the main body 27-I has penetrated in the hole 53-I, a slight gap is created between the outer surface of the main body 27-I and a peripheral surface of the hole 53-I. However, since the jutting portion 54-I that juts out from the outer end part of the main body 27-I reaches more outward than the peripheral surface of the hole 53-I and abuts an rear-side surface 14b-I of the chassis 14-I, the entire area of the hole 53-I is covered from the rear side by the jutting portion 54-I. In the mounted state, the outside part 27a-I of each lamp gripping portion 28-I among the main body 27-I is flush with an outside part 23a-I of the hole 53-I among the front surface of a reflection sheet 23-I. In addition, in the mounted state, the jutting portion 54-I, the chassis 14-I, and the reflection sheet 23-I line up in this order from the rear side.

Meanwhile, the entire areas of the mounting holes 32-I, 33-I are covered from the rear side by a portion where the mounting portions 30-I, 31-I are provided in the jutting portion 54-I. As a result, it is now possible to prevent: visual recognition of the hole 53-I and the mounting holes 32-I, 33-I as dark areas when an image is displayed on a liquid crystal panel 11-I while lighting a cold cathode tube 17-I; leakage of light to the rear side through the hole 53-I and the mounting holes 32-I, 33-I; and infiltration of outside dust in the chassis 14-I through the hole 53-I and the mounting holes 32-I, 33-I.

As described above, according to the present embodiment, the lamp clip 18-I is configured so as to be mounted on the chassis 14-I from a side opposite to a diffusing plate 15a-I (opening). Such a configuration enables diverse mounting modes of the lamp clip 18-I.

Moreover, the jutting portion 54-I that juts outward than the peripheral surface of the hole 53-I and that is capable of covering the hole 53-I is provided on the main body 27-I. Such a configuration enables the hole 53-I to be covered by the jutting portion 54-I of the main body 27-I to be mounted from the side opposite to the diffusing plate 15a-I (opening). Accordingly light does not pass through the hole 53-I. Furthermore, dust does not enter the hole 53-I.

In addition, while mounting holes 32-I, 33-I are provided on the chassis 14-I, mounting portions 30-I, 31-I that are to be inserted in the mounting holes 32-I, 33-I and that are capable of holding peripheral-edge parts of the mounting holes 32-I, 33-I between the main body 27-I are provided on the main body 27-I, and the jutting portion 54-I that protrudes along the chassis 14-I and that is capable of covering the mounting holes 32-I, 33-I are provided on the main body 27-I. With such a configuration, the mounting holes 32-I, 33-I are covered by the jutting portion 54-I and thus light does not pass through the mounting holes 32-I, 33-I. Furthermore, dust does not enter through the mounting holes 32-I, 33-I.

### Other Embodiments

The present invention is not limited to the embodiments disclosed by the above description and accompanying drawings and, for example, the embodiments described below also fall within the technical scope of the present invention.

(1) In addition to the embodiments described above, the shape of the lamp gripping portion can be modified, specific examples of that are shown in (2) to (5) below.

(2) While a configuration in which a first supporting protrusion is provided on the bottom surface of the lamp gripping portion has been shown in the embodiments described above, a configuration from which is omitted the first supporting protrusion is to be also included in the present invention. In this case, a bottom surface of a lamp gripping portion 28-J comes in plane-contact with an outer surface of a cold cathode tube 17-J over a predetermined range.

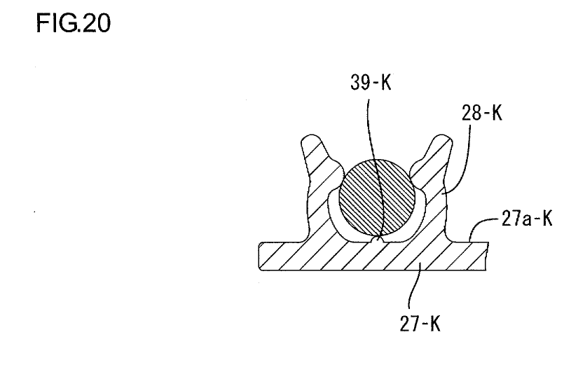

(3) While a configuration in which a recess is provided on the bottom surface of the lamp gripping portion has been shown in the embodiments described above, a configuration from which is omitted the recess is to be also included in the present invention. In this case, an outside portion 27a-K of a lamp gripping portion 28-K among a front-side surface of a main body 27-K can be configured so as to be flush with a bottom surface of the lamp gripping portion 28-K. Moreover, in combination with (2) described above, a configuration in which a first supporting protrusion 39-K has been omitted from a configuration illustrated in FIG. 20 is to be also included in the present invention.

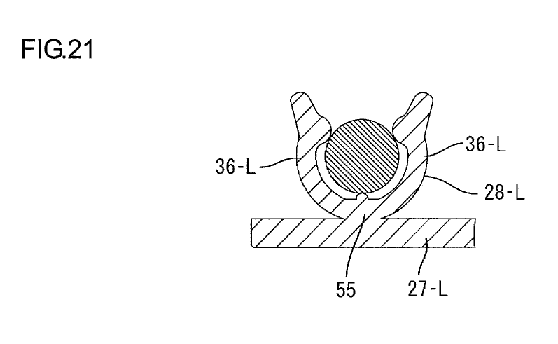

(4) While a configuration in which arm portions that make up a part of a lamp gripping portion is directly connected to a main body has been shown in the embodiments described above, as illustrated in FIG. 21, a configuration where a lamp gripping portion 28-L includes a pair of arm portions 36-L and a connecting part 55 that connects the arm portions 36-L to each other and that is connected to a front-side surface of a main body 27-L is to be also included in the present invention. Moreover, in combination with (2) described above, a first supporting protrusion can be omitted.

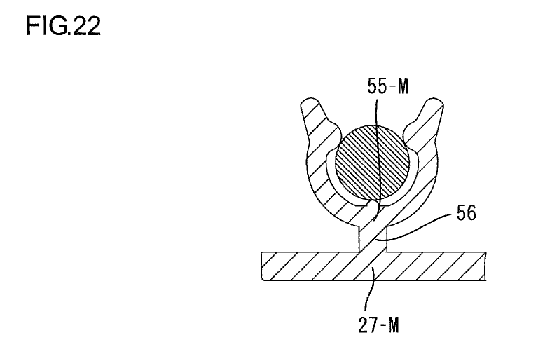

(5) As a further modification of (4) described above, as illustrated in FIG. 22, a configuration in which a connecting part 55-M and a front-side surface of a main body 27-M are linked to each other by a rising part 56 is to be also included in the present invention.

(6) While a configuration in which an entire area of a main body as seen in plan view is inserted in a recess or a hole has been shown in the embodiments described above, a configuration in which is formed a recess or a hole allowing penetration by only a part of the main body is to be also included in the present invention. In this case, a configuration in which only a part of the main body on which a lamp gripping portion is provided is inserted in a recess or a hole, a configuration in which only a part of the main body on which a lamp gripping portion is not provided is inserted in a recess or a hole, and a configuration in which a part of the main body on which a lamp gripping portion is provided and a part of the main body on which the lamp gripping portion is not provided are inserted in a recess or a hole are also included in the present invention.

(7) While a configuration in which a main body is formed in a plate-shape having a constant thickness has been shown in the embodiments described above, the present invention can also be applied to a configuration using a main body configured so as to have partial differences in thickness. In this case, a configuration may be adopted in which the main body includes a thin part and a thick part and only the thick part is inserted in a recess or a hole.

(8) In addition to the embodiments described above, the shape of a main body of a lamp clip may be appropriately modified. Specifically, configurations where a main body is shaped in a square as seen in plan view, a circle, an ellipse, and a polygon other than a quadrate as seen in plan view are to be also included in the present invention.

(9) In addition to the embodiments described above, the numbers of the mounting portions and the mounting holes can be appropriately modified. Configurations in which are respectively provided only one mounting portion and one mounting hole or three or more mounting portions and three or more mounting holes are to be also included in the present invention. Furthermore, the shapes of the mounting portion and the mounting hole can also be appropriately modified.

(10) In addition to the embodiments described above, the number, shape, arrangement, and the like of supporting pins of a lamp clip can be appropriately modified. Specifically, a plurality of supporting pins may be arranged. Furthermore, a supporting pin may be formed in a pyramid shape. Moreover, a supporting pin may be installed at an eccentric position with respect to a width direction of a main body.

(11) While a configuration in which a reflection sheet that is a separate part is laid in a chassis has been shown in the embodiments described above, a configuration in which a reflecting surface is formed in the chassis by, for example, applying a white paint with superior light reflectivity to an inner surface of the chassis is to be also included in the present invention. Furthermore, a configuration in which a chassis itself is formed by a white resin material and a reflecting surface is provided on a front surface of the chassis is to be also included in the present invention. In other words, the reflecting surface need not be separate from the chassis.

(12) While configurations where a cold cathode tube is used as a light source have been described in the embodiments above, configurations using other light sources such as a hot cathode tube are to be also included in the present invention.

(13) While a chassis made of sheet metal has been used in the embodiments described above, a chassis may alternatively be made by resin molding.

(14) While a TFT has been used as a switching element of a liquid crystal display device in the embodiments described above, the present invention can also be applied to a liquid crystal display device using a switching element other than a TFT (for example, a thin film diode (TFD) or to a black-and-white liquid crystal display device in addition to a color liquid crystal display device.

(15) While a liquid crystal display device using a liquid crystal panel as a display panel has been exemplified in the embodiments described above, the present invention can also be applied to a display device using another display panel type.

(16) While a television receiver apparatus including a tuner has been exemplified in the embodiments described above, the present invention can also be applied to a display device not including a tuner.

1. An illumination device comprising:
a lamp;
a chassis housing the lamp and having an opening through which light is output; and
a lamp holder including a main body mounted to the chassis and at least one lamp gripping portion provided on the main body so as to grip the lamp,
wherein the chassis has any one of a recess and a hole in which at least a part of the main body is inserted.

2. The illumination device according to claim 1, wherein the lamp gripping portion includes an arm portion that continues from the main body.

3. The illumination device according to claim 2, wherein a part of a surface of the lamp gripping portion opposing the lamp is a part of a front surface of the main body.

4. The illumination device according to claim 3, wherein the main body has a recessed portion in the part of the front surface that is also the part of the surface of the lamp gripping portion opposing the lamp .

5. The illumination device according to claims 2, wherein at least a part of the main body at which the lamp gripping portion is provided is inserted in any one of the recess and the hole.

6. The illumination device according to claim 1, wherein the lamp gripping portion further includes at least one supporting protrusion for supporting the lamp provided on the surface opposing the lamp.

7. The illumination device according to claim 6, wherein the supporting protrusion is provided at a part of the surface of the lamp gripping portion opposing the lamp, the part being farthest away from the opening.

8. The illumination device according to claim 7, wherein:
the lamp gripping portion includes a pair of arm portions rising from the main body; and
the at least one supporting protrusion includes a plurality of supporting protrusions provided at the arm portions of the lamp gripping portion and between the arm portions, respectively, so as to support the lamp with a three-point support.

9. The illumination device according to claim 8, wherein the recess is formed in a size such that the entire main body is inserted.

10. The illumination device according to claim 9, wherein the at least one lamp gripping portion includes a plurality of lamp gripping portions arranged on the main body.

11. The illumination device according to claim 1, wherein:
the chassis has a reflecting surface for reflecting light toward the opening; and
the main body has a shape such that the surface thereof lies on the same plane as the reflecting surface or closer to the opening than the reflecting surface.

12. The illumination device according to claim 1, wherein:
the chassis has a reflecting surface for reflecting light toward the opening; and
the main body has a shape such that the surface thereof is farther away from the opening than the reflecting surface.

13. The illumination device according to claim 1, wherein:
the chassis has a reflecting surface for reflecting light toward the opening, the reflecting surface lies on a different plane from the surface of the main body; and
the surface of the main body at least around an outer edge portion is formed so as to decline toward an outer edge of the main body such that a difference in height between the reflecting surface and the surface of the main body gradually decreases.

14. The illumination device according to claim 11, wherein the surface of the main body lies on the same plane as the reflecting surface.

15. The illumination device according to claims 1, wherein the chassis has a recess in which at least a part of the main body is inserted.

16. The illumination device according to claim 15, wherein:
the chassis has a mounting hole in the recess; and
the lamp holder has a mounting portion that is provided on the main body and inserted in the mounting hole such that a rim of the mounting hole is sandwiched between the main body and the mounting portion.

17. The illumination device according to claim 16, wherein:
the mounting portion includes a base portion that protrudes from the main body toward the chassis and an extending portion that extends from the base portion along the main body; and
the extending portion is inserted in the mounting hole such that the rim of the mounting hole is sandwiched between the main body and the extending portion when the lamp holder is slid in a direction along the main body.

18. The illumination device according to claim 17, wherein the main body includes a recess covering portion that extends in a sliding direction in which the main body is slid on the chassis so as to cover the recess.

19. The illumination device according to claim 16, wherein:
the mounting portion includes a base portion that protrudes from the main body toward the chassis and an extending portion that extends from the base portion along the main body; and
the extending portion is inserted in the mounting hole such that a rim of the mounting hole is sandwiched between the main body and the extending portion.

20. The illumination device according to claim 19, wherein the recess is formed in a size approximately the same as the main body.

21. The illumination device according to claim 15, wherein the chassis is formed such that a distance between a surface thereof on an opening side inside the recess and the opening differs from a distance between a surface outside the recess and the opening, and a distance between a surface thereof on a side away from the opening and the opening is constant.

22. The illumination device according to claim 1, wherein the chassis has a hole in which at least a part of the main body is inserted.

23. The illumination device according to claim 22, wherein the lamp holder is mounted to the chassis from the opening side.

24. The illumination device according to claim 23, further comprising a light transmissive optical member arranged over the opening,
wherein the lamp holder further includes a supporting portion that protrudes from the main body farther toward the optical member than the lamp gripping portion and supports the optical member.

25. The illumination device according to a claims 23, wherein the part of the main body inserted in the hole protrudes from a surface of the chassis on a side away from the opening.

26. The illumination device according to claims 23, wherein the main body includes a hole covering portion that projects farther out than a rim of the hole so as to cover the hole.

27. The illumination device according to claims 23, wherein:
the chassis has a mounting hole;
the lamp holder has a mounting portion inserted in the mounting hole such that a rim of the mounting hole is sandwiched between the main body and the mounting portion; and
the main body includes a mounting hole covering portion that protrudes along the chassis so as to cover the mounting hole.

28. The illumination device according to claim 22, wherein the lamp holder is mounted to the chassis from an opposite side from the opening.

29. The illumination device according to claim 28, wherein the main body includes a hole covering portion that projects farther out than a rim of the hole so as to cover the hole.

30. The illumination device according to claims 28, wherein:
the chassis has a mounting hole;
the lamp holder has a mounting portion that is inserted in the mounting hole such that a rim of the mounting hole is sandwiched between the main body and the mounting portion; and
the main body includes a mounting hole covering portion that protrudes along the chassis so as to cover the mounting hole.

31. The illumination device according to claim 1, further comprising a light transmissive optical member is arranged over the opening.

32. A display device comprising:
the illumination device according to claim 1; and
a display panel arranged in front of the illumination device.

33. The display device according to claim 32, wherein the display panel is a liquid crystal panel in which liquid crystals are sealed between a pair of substrates.

34. A television receiver apparatus comprising the display device according to claims 32.
